(19) United States
(12) Patent Application Publication
(10) Pub. No.: US 2008/0207461 A1
(43) Pub. Date: Aug. 28, 2008

(54) Devices for Conducting and Analyzing Microarray Experiments

(75) Inventors: Eugen Ermantraut, Jena (DE); Torsten Schulz, Jena (DE); Anke Woestemeyer, Jena (DE)

Correspondence Address: STEPTOE & JOHNSON LLP, 1330 CONNECTICUT AVENUE, N.W., WASHINGTON, DC, 20036, US

(73) Assignee: Clondiag Chip Technologies GMBH, Jena (DE)

(21) Appl. No.: 11/667,118

(22) PCT Filed: Nov. 9, 2005
(86) PCT No.: PCT/EP05/55871

§ 371 Date: Dec. 18, 2007

(30) Foreign Application Priority Data
Nov. 9, 2004 (DE) 10 2004 054 094.2
Nov. 24, 2004 (DE) 10 2004 056 735.2

(51) Int. Cl. C40B 30/02; C40B 60/12; C40B 50/14

(52) U.S. Cl. 506/8; 506/39; 506/30

(57) ABSTRACT

The present invention relates to devices for the simultaneous performance of microarray experiments for detecting specific interactions between probe and target molecules in a microtiter plate as well as to methods for manufacturing such devices. Furthermore, the present invention relates to the use of such devices in a method for qualitatively and/or quantitatively detecting specific interactions between probe and target molecules.

The present invention relates to devices for the simultaneous performance of microarray experiments for detecting specific interactions between probe and target molecules in a microtiter plate as well as to methods for manufacturing such devices. Furthermore, the present invention relates to the use of such devices in a method for qualitatively and/or quantitatively detecting specific interactions between probe and target molecules.

Biomedical tests are often based on the detection of an interaction between a molecule that is present in known amount and position (the molecular probe) and an unknown molecule to be detected or unknown molecules to be detected (the molecular target molecules). In modern tests, the probes are deposited in form of a substance library on supports, the so-called microarrays or chips, so that a sample can be analyzed simultaneously at various probes in parallel (see, for example, J. Lockhart, E. A. Winzeler, Genomics, gene expression and DNA arrays; Nature 2000, 405, 827-836). For manufacturing the microarrays, the probes are usually immobilized in a predetermined manner on a suitable matrix, as for example described in WO 00/12575 (see, for example, U.S. Pat. No. 5,412,087, WO 98/36827), or synthetically generated (see, for example, U.S. Pat. No. 5,143,854).

The detection of an interaction between the probe and the target molecule is usually conducted as follows: Upon to fixing the probe or the probes in a predetermined manner to a specific matrix in form of a microarray, the targets are contacted with the probes in a solution and are incubated under defined conditions. As a result of the incubation, a specific interaction occurs between probe and target. Thereby, the bond formed is significantly more stable than the bond of target molecules to probes that are not specific for the target molecule. In order to remove target molecules that have not specifically been bound, the system is washed or heated with corresponding solutions.

The detection of the specific interaction between a target and its probe can be performed by means of a variety of methods, which normally depend on the type of the marker that has been introduced into the target molecules before, during or after the interaction of the target molecule with the microarray. Typically, such markers are fluorescent groups, so that specific target/probe interactions can be read out fluorescence-optically with high local resolution and, as compared to other conventional detection methods, in particular to mass-sensitive methods, with little effort (A. Marshall, J. Hodgson, DNA chips: An array of possibilities, Nature Biotechnology 1998, 16, 27-31; G. Ramsay, DNA Chips: State of the art, Nature Biotechnology 1998, 16, 40-44).

Depending on the substance library immobilized on the microarray and the chemical nature of the target molecules, interactions between nucleic acids and nucleic acids, between proteins and proteins, and between nucleic acids and proteins can be examined by means of this test principle (for review see F. Lottspeich, H. Zorbas, 1998, Bioanalytik, Spektrum Akademischer Verlag, Heidelberg/Berlin, Germany).

For instance, antibody libraries, receptor libraries, peptide libraries, and nucleic acid libraries are considered substance libraries that can be immobilized on microarrays or chips. Nucleic acid libraries take by far the most important role. These are microarrays, on which deoxyribonucleic acid (DNA) molecules or ribonucleic acid (RNA) molecules are immobilized.

It is a prerequisite for binding, for example, of a target molecule labeled with a fluorescence group in form of a DNA or RNA molecule to a nucleic acid probe of the microarray that both target molecule and probe molecule are present in form of a single-stranded nucleic acid. An efficient and specific hybridization can only occur between such molecules. Single-stranded nucleic acid target molecules and nucleic acid probe molecules can normally be obtained by means of heat denaturation and optimal selection of parameters like temperature, ionic strength, and concentration of helix-destabilizing molecules. Thus, it is ensured that only probes having almost perfectly complementary sequences, i.e. sequences corresponding to each other, remain paired with the target sequence (A. A. Leitch, T. Schwarzacher, D. Jackson, I. J. Leitch, 1994, In vitro Hybridisierung, Spektrum Akademischer Verlag, Heidelberg/Berlin/Oxford).

In order to conduct these tests in practice, the microarrays or chips are, for example, fixed in sealed chambers having inlets and outlets for changing the liquids required for the washing and hybridization steps. Such systems are, for example, described in U.S. Pat. No. 6,287,850 and in WO 01/02094. In DE 199 40 750, a support for analyte determination methods is described, which, after slight constructional modifications, is also suitable for the use in array applications within the scope of the present invention.

For DNA sequence analysis, surface-bound DNA libraries applied on object supports are conventionally used. For conducting the hybridization reaction on said object supports, special hybridization chambers or incubation chambers are currently used. In order to ensure tempering and mixing of the hybridization solution in said currently known chambers, an equipment is required that is specifically adapted to the device used and is therefore intricate and expensive.

In DE 101 49 684 A1, a flow cell suitable for conducting a PCR as well as hybridization reactions on DNA chips is described. The flow cell described is a complex component that is provided with a variety of technical characteristics, which exclude the use of equipment conventionally used in laboratories, such as devices for handling microtiter plates.

In WO 01/02094, a cartridge comprising a DNA chip is described. Within said cartridge, both a PCR and a hybridization reaction on a DNA chip can be conducted.

In WO 95/33846, a body is described having a recess into which a substrate bearing nucleic acid molecules of known sequence is integrated on defined regions. The body has a sealed cavity into which the sample liquid can be injected. The filling channels are sealed via septa and are opened by means of suitable injection needles in order to fill the body or the cartridge. The use of the previously described cartridges also requires equipment specifically provided to this end.

In U.S. Pat. No. 5,856,174, a miniaturized integrated nucleic acid diagnostic device is described. Said device enables collecting and preparing one or more samples and subsequently conducting several sample analyses. Such a device serves for automatically conducting an analysis based on DNA chips by means of uniting and miniaturizing all incidental steps on one cartridge. Providing such a device is extremely laborious and expensive.

On the basis of the previously described prior art it becomes evident that there is a great need for devices that can not only be provided easily and cost-effectively, but also enable an easy simultaneous performance of detection tests based on microarrays on the other hand. In particular, there is a need for devices for conducting tests based on microarrays that enable the use of typical devices and instruments of everyday laboratory use. In general, there is a need for devices for conducting tests based on microarrays that are characterized by simple construction, easy operability, prevention of contamination sources, reproducible conductibility of the tests, and low manufacturing costs.

In U.S. Pat. No. 5,545,531 and U.S. Pat. No. 5,874,219, methods for conducting reactions with microarrays in parallel are described. The devices employed therein comprise a wafer carrying several microarrays and forming the bottom of a multi-well plate, wherein a microarray is located in each of the wells of the multiwell plate. Detecting the probe/target interactions on the arrays is carried out by means of reading out the signals of fluorescent, light-scattering, or radioactive labels. The embodiment of a complete wafer as bottom of a multiwell plate has the disadvantage that only one defective array on the wafer will lead to a defective multiwell plate. Quality control of individual microarrays on the wafer is not possible.

The possibility of arranging individual microarrays in wells of microtiter plates is indeed mentioned in U.S. Pat. No. 5,545,531 and U.S. Pat. No. 5,874,219. However, in the microtiter plates shown therein, empty spaces will form between the side walls of the wells and the side surfaces of the biochips. Analyte solutions as well as washing solutions may be displaced into such empty spaces, so that an exact detection is no longer ensured.

Finally, a disadvantage of the detection methods described in U.S. Pat. No. 5,545,531 and U.S. Pat. No. 5,874,219 is the sometimes considerable technical effort required as well as the high costs connected with the detection methods. Furthermore, detecting the labels is only possible from underneath, i.e. through the bottom of the microtiter plate, as a detection by means of the detection methods described therein is not possible due to the inhomogeneity of the liquid level of the solution located above the bioarray. Even if the solution above the array was laboriously removed, solution residues impeding the detection would still remain.

In WO 04/065009, there is also described a device for conducting microarray methods in parallel. The device comprises a support having at least one reaction chamber in which biologically active molecules are immobilized. The reaction chamber has a ratio of bottom surface to wall height of at least 30:1. This extremely low wall, as compared to the wells of conventional microtiter plates, is intended to prevent any disturbing influence on the detection caused by the boundary of the reaction chamber. Furthermore, applying the biologically active molecules onto a surface within the reaction chamber is supposed to be facilitated by the low wall. The detection reaction on the microarray and possible washing steps require putting a top piece in form of a volume increasing device onto the biochip. Detection can be carried out by means of various methods like fluorescence, luminescence, or spectroscopic methods. The devices described in WO 04/065009 are disadvantageous with regard to the high technical effort required for detection as well as the impeded operability of the device due to the volume increasing devices to be employed.

Thus, it is a problem underlying the present invention to provide a device for conducting array experiments in parallel, characterized by simple construction, easy operability and therefore cost-effective manufacturing. It is a further problem underlying the present invention to provide a device for conducting microarray experiments in parallel that is compatible with conventional laboratory devices for processing microtiter plates and that enables conducting tests based on microarrays in parallel while avoiding contamination sources. Finally, it is a problem underlying the present invention to provide a device for conducting array methods that enables the use of detection methods at comparatively low technical effort.

Diagnostic tests on the basis of multiparameter analyses with surface-bound substance libraries, i.e. on the basis of microarrays, could hardly gain acceptance up to now, on the one hand because validating the tests was too laborious for individual diagnostic laboratories due to their complexity and, on the other hand, due to a lack of the means or devices required for providing standardized test methods on the basis of microarrays in such a way that a user is rendered capable of conducting said test method without extensive instructions. Up to now, it has proven to be especially problematic to provide tests on array basis that are validated and correspond to the respective legislation for medicinal products, as a standardized performance and evaluation at different operating locations was economically impossible for such a test due to the multiplicity of operating instructions and parameters. This applies even more in cases where a high throughput of tests is supposed to be achieved.

Another problem underlying the present invention is the provision of a device ensuring an easy performance of tests based on microarrays, in particular for diagnostic purposes. Furthermore, it is another problem underlying the present invention to provide standardized and optionally validated tests based on microarrays that can easily be conducted, irrespective of operator or location of the test.

These and further problems underlying the present invention are solved by providing the objects stated in the patent claims. Preferred embodiments are defined in the subclaims.

According to the present invention, these problems are particularly solved by means of providing a device for the simultaneous performance of microarray experiments for detecting a specific interaction between probe and target molecules, comprising a microtiter plate, in wells of which there is each an individual microarray essentially continuously integrated having probes molecules arranged on predetermined regions thereof.

The devices according to the present invention for detecting specific interactions between molecular target and probe molecules provide the substantial advantage that the acquisition of additional devices or additional equipment for conducting the detection reactions is not required, as those devices that are conventionally used in laboratories, in particular in biological laboratories, for the handling of conventional microtiter plates employed for the simultaneous performance of medical or biological tests or reactions can be used as well. Thus, for example, conventional devices for filling, moving, or tempering microtiter plates having standard formats are compatible with the devices according to the present invention.

The arrangement of the microarrays in a microtiter plate enables the detection of the interaction reaction between target and probe molecules by means of conventional methods, such as by means of fluorescence detection or radiochemical methods. The use of absorption measurements has proven to be particularly advantageous, since they can be conducted in a particularly cost-effective manner. Such an absorption measurement can, for example, be conducted using a catalytically controlled reaction, in which a precipitate is formed in a site-specific manner at those surface regions where an interaction reaction has occurred. In order to detect said precipitates, a detection device can be used that employs one or more light-emitting diodes of optional emission wavelength as light source and that has, for example, a CCD camera for locally resolved detection of the interaction reaction in the predetermined regions of the chip.

In a further aspect of the present invention, a method for manufacturing a device for the simultaneous performance of microarray experiments for detecting a specific interaction between probe and target molecules on a microtiter plate is provided. The wells of the microtiter plates employed in the method according to the present invention each have a microarray with probe molecules arranged in predetermined regions of the microarray. The method according to the present invention comprises the following steps:
a) generating microarrays having probe molecules arranged in predetermined regions of the microarray;
b) examining the quality of the microarray generated in step a);
c) selecting suitable microarrays; and/or
d) fixing the microarrays selected in step c) in wells of the microtiter plate.

The method according to the present invention for manufacturing the devices for detecting biopolymers on microtiter plates has the significant advantage that it comprises the performance of a quality control and thus enables the selection of those microarrays or chips meeting the quality requirements.

In a further aspect of the present invention, an arrangement for conducting and analyzing microarray experiments for detecting a specific interaction between probe and target molecules is provided comprising:
a microtiter plate, in wells of which there is each an individual microarray essentially continuously integrated having probes molecules arranged on predetermined regions thereof; and
a detector device for detecting a specific interaction between probe and target molecules arranged in predetermined regions of the microarray.

In a further aspect of the present invention, an arrangement for conducting and analyzing microarray experiments for detecting a specific interaction between probe and target molecules is provided, comprising:
at least one reaction tube, in which a microarray having probe molecules arranged in predetermined regions of the microarray is integrated;
a detector device for detecting a specific interaction between probe and target molecules arranged in predetermined regions of the microarray;
a processing device for processing the specific interaction recorded by means of the detector device on the basis of a processing instruction that can be predetermined externally in a selective manner and that is preferably validated.

In a further aspect of the present invention a method is provided for processing a specific interaction between target molecules and probe molecules arranged in predetermined regions of a microarray that has been recorded by means of an arrangement for conducting and analyzing microarray experiments, wherein in the method a specific interaction recorded by means of the detector device is processed on the basis of a processing instruction that can be predetermined externally and selectively.

In a further aspect of the present invention, a computer-readable storage medium is provided, on which a program is stored for processing a specific interaction between target molecules and probe molecules arranged in predetermined regions of a microarray that has been recorded by means of an instruction for conducting and analyzing microarray experiments, wherein in the program, in case it is conducted by means of a processor, a specific interaction recorded by means of a detector device is processed on the basis of an externally and selectively predetermined processing instruction.

In a further aspect of the present invention, a program element is provided, on which a program is stored for processing a specific interaction between target molecules and probe molecules arranged in predetermined regions of a microarray that has been recorded by means of an instruction for conducting and analyzing microarray experiments, wherein in the program, in case it is conducted by means of a processor, a specific interaction recorded by means of a detector device is processed on the basis of an externally and selectively predetermined processing instruction.

Finally, the present invention relates to the use of the devices and/or instructions according to the present invention, as described above, for the simultaneous performance of microarray experiments in a method for qualitatively and/or quantitatively detecting the specific interaction between probe and target molecules, comprising the following steps:
a) interaction of the targets with probes arranged in predetermined regions (array elements) of the microarray; and
b) detecting said interaction.

Furthermore, the following definitions are used for describing the present invention:

Within the scope of the present invention, a microtiter plate is understood to denote a one- or two-dimensional arrangement or a grid of separate reaction tubes or cavities or recesses on a plate that is used for the simultaneous performance of biological, chemical and/or medical laboratory tests or reactions. Microtiter plates within the present invention have common formats and dimensions of conventional microtiter plates known to the person skilled in the art and available, for example, from the manufacturers Nunc (Roskilde, Denmark,) Greiner Bio-One (Frickenhausen, Germany) or VWR International (Vienna, Austria). Usually they consist of polycarbonate or polypropylene. For instance, the microtiter plates corresponding to so-called 96 well or 384 well microtiter plates comprise 8×12 or 16×24 cavities. A conventional microtiter plate is shown in FIG. 1.

The external dimensions of the devices according to the present invention thus correspond to the standard dimensions conventional for microtiter plates, i.e. about 127.76 mm×about 85.48 mm plate length×plate width, wherein the wall heights of the individual wells conventionally are within a range of from about 14 mm to about 14.5 mm, so that they can be, for example, filled, moved and tempered by means of standard laboratory devices for handling microtiter plates. Typical filling volumes for individual wells are, as with standard microtiter plate formats, within a range of a few μl to a few 100 μl, according to the degree of parallelism of the device according to the present invention.

Shape and geometry of the individual wells of the device according to the present invention are, as with standard formats of microtiter plates and strips, for example cylindrical, conical or cuboidal. Preferably, the wells have a planar bottom base whose basic shape is usually rectangular, square, or circular.

Within the scope of the present invention, the term microtiter plate also comprises so-called well strips or strips or ELISA strips. Within the scope of the present invention, such a well strip is understood to denote a one-dimensional arrangement of, for example, eight or twelve separate wells on a plate or a strip, as are for example available from the manufacturers Nunc and Greiner. A conventional well strip is shown in FIG. 2.

In case the microarrays are integrated in wells of such a well strip in an embodiment of the present invention, they can, just as the conventional strips of standard shape and size, be attached in holder frames having external dimensions of the size and shape of microtiter plates, either individually or in a combined manner, to form a microtiter plate consisting of up to twelve or more strips in order to be processed by means of standard devices for handling microtiter plates. This enables the individual provision of a microtiter plate consisting of strips with probe arrays for various applications.

Within the scope of the present invention, a microarray or probe array or bioarray is understood to denote an arrangement of molecular probes or a substance library on a support, wherein the position of each probe is determined separately. Preferably, the array comprises defined sites or predetermined regions, so-called array elements, which are particularly preferably arranged in a particular pattern, wherein each array element usually comprises only one species of probes. The arrangement or the immobilization of the molecules or probes on the support can be generated by means of covalent or non-covalent interactions. Herein, the probes are arranged at the side of the support facing the reaction chamber inside the wells. A position within the arrangement, i.e. within the array, is usually referred to as spot.

Within the scope of the present invention, a probe or a probe molecule is understood to denote a molecule which is used for the detection of other molecules due to a particular characteristic binding behavior or a particular reactivity. Each type of molecules which can be coupled to solid surfaces and have a specific affinity can be used as probes arranged on the array. In a preferred embodiment, these are biopolymers, in particular biopolymers from the classes of peptides, proteins, antigens, antibodies, carbohydrates, nucleic acids, and/or analogs thereof and/or mixed polymers of the biopolymers mentioned above. Particularly preferably, the probes are nucleic acids and/or nucleic acid analogs. Both DNA and RNA molecules can be used as nucleic acids. For example, the oligonucleotide probes can be oligonucleotides that have a length of 10 to 100 bases, preferably of 15 to 50 bases, and particularly preferably of 20 to 30 bases and are immobilized on the array surface.

In particular, nucleic acid molecules of defined and known sequence, which are used for detecting target molecules in hybridization methods, are referred to as probe. Both DNA and RNA molecules can be used as nucleic acids. For example, the nucleic acid probes or oligonucleotide probes can be oligonucleotides having a length of 10 to 100 bases, preferably of 15 to 50 bases, and particularly preferably of 20 to 30 bases. Typically, according to the present invention, the probes are single-stranded nucleic acid molecules or molecules of nucleic acid analogs, preferably single-stranded DNA molecules or RNA molecules having at least one sequence region which is complementary to a sequence region of the target molecules. Depending on detection method and application, the probes can be immobilized on a solid support in form of a microarray. Furthermore, depending on the detection method, they can be labeled radioactively or non-radioactively, so that they are detectable by means of a detection method that is conventional in the art.

Within the scope of the present invention, a target or a target molecule is understood to denote the molecule to be detected by means of a molecular probe. In a preferred embodiment of the present invention, the targets to be detected are nucleic acids. However, the probe array according to the present invention can also be used analogously for detecting peptide/probe interactions, protein/probe interactions, carbohydrate/probe interactions, antibody/probe interactions etc.

If, within the scope of the present invention, the targets are nucleic acids or nucleic acid molecules that are detected by means of a hybridization against probes arranged on a probe array, said target molecules normally comprise sequences having a length of 40 to 10,000 bases, preferably of 60 to 2,000 bases, also preferably of 60 to 1,000 bases, particularly preferably of 60 to 500 bases and most preferably of 60 to 150 bases. Optionally, their sequence comprises the sequences of primers as well as the sequence regions of the template that are defined by the primers. In particular, the target molecules can be single-stranded or double-stranded nucleic acid molecules one or both strands of which are labeled radioactively or non-radioactively, so that they are detectable by means of a detection method conventional in the art.

According to the present invention, a target sequence denotes the sequence region of the target that is detected by means of hybridization with the probe. According to the present invention, this is also referred to as said region being addressed by the probe.

Within the scope of the present invention, a substance library is understood to denote a multiplicity of different probe molecules, preferably at least two to 1,000,000 different molecules, particularly preferably at least 10 to 10,000 different molecules, and most preferably between 100 to 1,000 different molecules. In special embodiments, a substance library can also comprise only at least 50 or less or at least 30,000 different molecules. Preferably, the substance library is arranged in form of an array on a support inside the reaction chamber of the device according to the present invention. An arrangement of the substances or probe molecules on the support is preferably conducted in such a way that a specific, unambiguously identifiable site is assigned to each substance or each species of probe molecules and that each substance or each species of probe molecules is immobilized separately from the others.

Within the scope of the present invention, an array element or a predetermined region or a spot or an array spot is understood to denote an area on a surface that is determined for the deposition of a molecular probe; the entirety of all occupied array elements is the microarray or the probe array.

Within the scope of the present invention, a support element or support or substance library support or substrate is understood to denote a solid body on which the probe array is set up. The support, usually also referred to as matrix, can for example denote an object support or a wafer or ceramic materials.

The entirety of molecules arranged in array layout on the substrate, or the substance library arranged in array layout on the substrate or the detection area and on the support or substrate is also often referred to as “chip”, “biochip”, “microarray”, “DNA chip”, “probe array” etc.

Conventional arrays or microarrays within the scope of the present invention comprise about 2 to 10,000, preferably 10 to 2,000, and particularly preferably at least 30 or at least 100 different species of probe molecules or biopolymers on a preferably square surface of, for example, 1 mm to 5 mm×1 mm to 5 mm, preferably of 2 mm×2 mm or about 17.64 mm². In further embodiments, microarrays within the scope of the present invention comprise about 50 to about 80,000, preferably about 100 to about 65,000, particularly preferably about 1,000 to about 10,000 different species of probe molecules on a surface of several mm² up to several cm², preferably about 1 mm² to 10 cm², particularly preferably 2 mm² to about 1 cm², and most preferably about 4 mm² to about 6.25 mm². For example, a conventional microarray has 100 to 65,000 different species of probe molecules on a surface of about 4.2 mm×4.2 mm. Further exemplary sizes of the surfaces of the microarray or the surfaces for the synthesis of the biopolymers are about 1 to 10 mm×about 1 to 10 mm, preferably about 2 to 5 mm×about 2 to 5 mm, and particularly preferably about 3.5 to 4.5 mm×about 3.5×4.5 mm.

Within the scope of the present invention, a biochip array or a biochip microtiter plate is understood to denote an arrangement of bioarrays or microarrays on a microtiter plate or a well strip, wherein the bioarrays are integrated in the wells of the microtiter plate or of the well strip. The microtiter plate or the well strip of the device according to the present invention will also be referred to as array, microarray, bioarray, or biochip support in the following.

Within the scope of the present invention, a substantially continuous integration of a microarray in a well is understood to denote that the microarray is arranged in said well in such a way that the surface of the bottom or of the side wall or of the lid of the well with the microarray arranged therein or thereon is substantially planar. Since the microarray is substantially continuously integrated in the well, there are substantially no empty spaces formed between the side walls of the microarray and the neighboring walls of the well, which may result from the fact that the base of the microarray is smaller than the base of the well the microarray is arranged on.

Within the scope of the present invention, an individual microarray is understood to denote that only one substance library is arranged on the support of the microarray; i.e. the microarrays integrated in wells of a microtiter plate, in accordance with the present invention, have no coherent support. Thus, a separate microarray is integrated in one well. An individual microarray is not connected to other microarrays via a common support.

Within the scope of the present invention, a label is understood to denote a detectable unit, for example a fluorophore or an anchor group, whereto a detectable unit or a catalyst catalyzing the conversion of a soluble educt or substrate to form an insoluble product or a crystal nucleus can be coupled.

Within the scope of the present invention, an educt or substrate (in the sense of an enzymatic substrate) is understood to denote a molecule or a combination of molecules present in the reaction medium in a dissolved state, which is/are locally precipitated with the aid of a catalyst or a crystal nucleus and/or a converting agent. The converting agent can, for example, be a reducing agent, like in silver precipitation, or an oxidizing agent, like in generating a dye by means of enzymatic oxidation.

Within the scope of the present invention, a sample or sample solution or analyte is understood to denote the liquid to be analyzed containing the target molecules to be detected and, optionally, to be amplified.

Within the scope of the present invention, an amplification reaction usually comprises 10 to 50 or more amplification cycles, preferably about 25 to 45 cycles, particularly preferably about 40 cycles. Within the scope of the present invention, a cyclic amplification reaction preferably is a polymerase chain reaction (PCR).

Within the scope of the present invention, a molecular interaction or an interaction is, in particular, understood to denote a specific covalent or non-covalent bond between a target molecule and an immobilized probe molecule. In a preferred embodiment of the present invention, the interaction between probe and target molecules is a hybridization.

The formation of double-stranded nucleic acid molecules or duplex molecules from complementary single-stranded nucleic acid molecules is referred to as hybridization. Thereby, the association preferably always occurs in pairs of A and T or G and C, respectively. Preferably, an association can also occur via non-classical base pairings like wobble base pairings, for example between inosine and G or inosine and C, respectively. Within a hybridization, for example DNA-DNA duplexes, DNA-RNA duplexes, or RNA-RNA duplexes can be formed. By means of a hybridization, duplexes with nucleic acid analogs can also be formed, such as DNA-PNA duplexes, RNA-PNA duplexes, DNA-LNA duplexes, and RNA-LNA duplexes. Hybridization experiments are usually emplyed for detecting the sequence complementarity and therefore the identity between two different nucleic acid molecules.

Within the scope of the present invention, processing is particularly understood to denote steps of sample transfer, incubation, purification, concentration, labeling, amplification, interaction or hybridization and/or washing or rinsing, as well as further method steps for the detection of targets by using substance libraries.

Within the scope of the present invention, a validated test or a validated experiment is understood to denote a test, in particular a test based on microarrays, that yields a defined result under identical conditions, such as identical temperature.

Within the scope of the present invention, an array arrangement (layout) is understood to denote the arrangement of the spots on an array, i.e. in particular the spatial distribution of the spots on an array, as well as, optionally, the arrangement and type of reference spots.

Within the scope of the present invention, an assignment table is understood to denote the assignment of the spots or of the corresponding signals to the probe species arranged thereon, a correlation of spots or the corresponding signals to one another, such as the correlation of spots with probes directed against wild type and mutant and/or the assignment of the probe species or of the corresponding signal to the problem, in particular a diagnostic problem, to be analyzed.

Within the scope of the present invention, a threshold value table is understood to denote the threshold measurement at a spot starting from which a signal is classified to be a positive signal.

Thus, a first object of the present invention is a device for the simultaneous performance of microarray experiments for detecting a specific interaction between probe and target molecules, comprising a microtiter plate or a well strip with microarrays, in wells of which microtiter plate or well strip there is each a individual microarray essentially continuously integrated having probes molecules arranged on predetermined regions thereof. Preferably, a microarray is integrated in each well of the microtiter plate. However, embodiments in which one or more wells do not contain any microarrays are also conceivable.

Thus, the device according to the present invention comprises an arrangement of standard reaction tubes in microtiter plate format. The device according to the present invention, for example in 96 well microtiter plate format, differs from the conventional standard microtiter plates in that it has a microarray having probe molecules arranged in predetermined regions integrated in each well for conducting a molecular analysis. Such a microarray having probe molecules immobilized in predetermined regions thereon will also be referred to as chip or affinity matrix in the following. The predetermined regions on the support will also be referred to as array elements in the following.

Usually, the base of a well, on which the microarray or the support element with the probe molecules immobilized in predetermined regions is arranged or integrated, is the bottom of a well of the microtiter plate of the device according to the present invention. If required for technical reasons, the microarray or the chip can also be incorporated or integrated in the side walls of a well.

In an alternative embodiment, the microarrays are integrated in a covering device or a lid of the microtiter plate. Usually, such a covering device is a separate unit with which the wells of the device according to the present invention can be sealed in a liquid-proof manner and the arrays located in the lid can be contacted with the respective solution during specific reaction steps. Incorporating the support element or the chip surface in a lid is in particular advantageous in cases where the affinity matrix reacts sensitive to the conditions in one or more of the reaction steps for preparing and/or conducting the detection reaction. In this embodiment of the device according to the present invention, such reaction steps can be conducted in the vertically standing device, whereby the affinity matrix or the chip is not contacted with the reaction and sample solutions and is thus protected. For conducting the detection reaction, the device according to the present invention is then turned upside down to stand on its lid, so that the sample is contacted with the surface-bound probes. In this manner, the thermal and chemical strain on the affinity matrix or on the chip is reduced.

The microarrays of the device according to the present invention are integrated in the respective well in a substantially continuous manner, so that there are substantially no empty spaces or no gaps or no free regions between the side walls of the microarray and the neighboring walls of the well.

In one embodiment of the present invention this is achieved in that the base of a microarray to be integrated corresponds exactly to the base of the well on which the microarray is fixed. In this manner, the microarray can be snugly integrated into a well leaving no undesired empty spaces at the sides of the microarrays.

However, the base of the microarray usually is smaller than the base of the well the microarray is arranged on. In the following, embodiments by means of which it is possible to achieve a continuous integration in such a case will be described in an exemplary manner.

In one embodiment, the substantially continuous integration can be achieved in that one microarray is fixed on the base of each of the wells and that there is a spacer arranged between the microarray and the side walls of the well. According to shape or geometry of the base of the well, such a spacer can, for example, be a wedge or a ring or a hardenable compound that substantially occupies the empty spaces between the microarray and the side walls of the well completely. The spacer is made of a material that is inert to the reagents used in the detection reactions within the scope of the present invention and is preferably made of the same material as the wells or the microtiter plate. Also preferred are materials selected from the group consisting of glass, glass ceramics, plastic-coated glass and synthetic materials or organic polymers like elastomers, polypropylene, polyethylene, polystyrene, poly-carbonate, PVC, polymethylmethacrylate, silicone plastic, rubber, polytetrafluorethylene and/or nylon. Metals, in particular stainless steels, platinum and/or aluminum are also conceivable for special embodiments.

Preferably, the spacer is developed in such a way that it fills up empty spaces or gaps or free regions between the microarray and the side walls of a well substantially completely. In a further embodiment, the wells each have a retainer in which the microarrays are fixed. Such a retainer or recess or opening is preferably prefabricated within the bottom or the bottom surface of a well. The respective microarray will engage in said opening. Preferably, the engagement occurs in a form-closed manner.

In a further embodiment the wells each have a recess or opening in which the microarrays are fixed. The microarray can, for example, be fixed in such a recess from the inside and/or from the outside. In these embodiments, the device according to the present invention has a shape and size that is typical for a microtiter plate and has, in the wells, an opening formed as a margin for receiving the microarrays or affinity matrices, in particular the surface-bound substance libraries, respectively. In particular, the microarrays are fixed in an opening in case the wells have a conical shape.

Preferably, the microarrays are fixed in the wells in an adhesive, clicking, clamping and/or magnetic manner. Alternatively, fixing the microarrays can be conducted by means of screwing and/or welding, in particular by means of laser welding. Beside the previously mentioned variants, further ways of fixing the microarrays are also conceivable.

Incorporating or fixing the microarrays in the wells from the inside, for example by means of gluing them to the bottom of the wells, has the advantage that the microarray or chip in the microtiter plate cannot be pushed out of its attachment toward the outside, not even as the internal pressure increases, for example, in case of use in a centrifuge or in case of heating the sample liquid up to temperatures near the boiling point.

Clamp connections or screw threads or notches have the advantage of providing a force-fit and liquid-proof connection between well and support or chip. Such variants combine the advantages of inserting the support or chip into the reaction tube from the inside with those of a simplified installation.

The manufacture of the device according to the present invention usually starts out from a standard microtiter plate or from standard strips—in particular those by one of the previously mentioned manufacturers, such as Greiner Bio-One—in each of whose wells one microarray is implemented or integrated. Alternatively, the basic bodies of the wells of the device according to the present invention can be manufactured in form of a microtiter plate in standard formats, for example by means of injection molding.

When fixing the microarrays in a recess of the wells, they are usually trimmed at the bottom and then recast. Such a method is in particular suitable for lower numbers of pieces. In case of larger numbers of pieces, it is advantageous to directly injection-mold the microtiter plate to form one of the previously mentioned embodiments.

The material of the microtiter plate or of the wells corresponds to the materials conventionally used for microtiter plates. Preferably, the materials are selected in such a way that the devices according to the present invention will behave in a thermally, mechanically and thermo-mechanically stable manner under reaction conditions that are typical for molecular detection reactions. Furthermore, the material of the microtiter plate or of the wells should preferably not react in any way with the materials and reagents that are conventionally employed in molecular tests, i.e. it should be chemically and/or biochemically inert. The material of the microtiter plate or of the wells is, for example, selected from the group consisting of glass, glass ceramics, plastic-coated glass and synthetic materials or organic polymers like polypropylene, polyethylene, polystyrene, polycarbonate, PVC, polymethylmethacrylate, silicone plastic, rubber, polytetrafluorethylene and/or nylon. Metals, in particular stainless steels, platinum and/or aluminum are also conceivable for special embodiments. Polypropylene and polyethylene are particularly preferred.

Preferably, the materials of the wells or microtiter plates into which the probe arrays are incorporated are sufficiently transparent, at least in the region of the base of the well, to ensure an optical detection of interactions on the microarray, in particular by means of transmission measurements within the visible range of wavelengths.

The wells of the microtiter plates have a size that is typical for standard microtiter plates. Typical filling volumes of a well lie within a range of about 5 μl to about 350 μl; they can, however, be higher or lower in special embodiments. Particularly preferably, the wells have a filling volume that is conventional for a standard microtiter plate in 384 format of 5 μl to 100 μl or a filling volume that is conventional for a standard microtiter plate in 96 format of 10 μl to 350 μl. Further preferred filling volumes of a well are about 50 μl, about 150 μl, or about 250 μl.

In a particularly preferred embodiment, the microarrays are glued to the base, preferably the bottom, of the wells, wherein one microarray is preferably fixed in each well. In order to ensure a continuous integration of the microarrays into the wells in this embodiment, the glue used for the adhesive fixing of a microarray to the base of a well preferably also fills up the empty spaces between the microarray and the side walls of the well substantially completely. In this embodiment, the glue serves as spacer between the microarray and the side walls of the well. In this way, it is achieved that the detection area of the microarray is integrated in a planar surface on the bottom of the well. The disadvantageous displacement of analyte or washing solutions into gaps formed between the microarray and the side walls of the wells is thus avoided.

Preferably, the adhesives employed for this behave in a thermally, mechanically and thermo-mechanically stable manner under reaction conditions that are typical for molecular interaction reactions. Furthermore, the adhesives employed for fixing the microarrays should preferably not react in any way with the materials and reagents that are conventionally employed in molecular tests, i.e. they should be chemically and/or biochemically inert.

In case the microarrays in the devices according to the present invention are fixed by means of gluing, for example if they are glued to the bottom of a well, they are usually applied by means of conventional dispensing devices. Preferably, UV- or UV-VIS-curing adhesives, for example urethane acrylate like NOA76 (Norland, N.J., USA) and Vitralit VBB-1 (Panacol-Elosol, Germany) and modified acrylates like Photobond 4496, Photobond 4436 and Photobond 4442 (all available from Delo, Germany), and platinum-curing polydimethylsiloxanes like Sylgard 182 or Sylgard 184 (Dow Corning, Midland, Mich., USA) may preferably be considered as adhesives. Alternatively, other adhesives, such as silicone adhesive, polyurethane adhesive, epoxide resin adhesive, cyanoacrylate adhesive, acryl adhesive and/or hot-melt adhesive can be employed.

Examples of further suitable adhesives are one-component silicone such as Elastosil E43 (Wacker-Chemie GmbH, Munich, Germany), two-component silicone such as Sylgard 182 and 184 (Dow Corning Corporation, Wiesbaden, Germany); polyurethane resin such as Wepuran VT 3402 KK (Lackwerke Peters GmbH & Co. KG, Kempen, Germany); epoxide resins such as SK 201 (SurA Chemicals GmbH, Jena, Germany); and/or acrylates such as Scotch-Weld DP 8005 (3M Deutschland GmbH, Hilden, Germany).

In a further preferred embodiment, an adhesive used for adhesively fixing the microarrays in the wells and a spacer used for continuously integrating the microarray into the wells consist of different materials.

Particularly preferably, the spacer and/or the adhesive used is an elastomer. Elastomers have the advantage of being elastic and therefore avoiding tensions when fixing the arrays. Examples for preferred elastomers are the previously mentioned silicone elastomers.

When fixing microarrays in retainers and/or recesses, for example, different rubbers like silicone rubber and/or rubber materials and the like can be employed as sealing materials.

Alternatively, a microarray is fixed, for example, to the bottom of a well by means of clamping it into an opening. Said adhesive-free fixing is usually achieved by means of heating the material of the well. Heating the material will widen the opening owing to the linear expansion coefficient of the material. The microarray is then placed into the retainer or the opening. The microarray is fixed by cooling the material which results in shrinking. Thus, in a further preferred embodiment, the device according to the present invention contains a material having a high linear expansion coefficient, in particular within a temperature range of 20° C. to 100° C., particularly preferably within a temperature range of 25° C. to 80° C., particularly preferably having a linear expansion coefficient within a range of 0.1×10⁴ K⁻¹ to 1.5×10⁻⁴ K⁻¹ and most preferably of 0.5×10⁻⁴ K⁻¹ to 1.0×10⁻⁴ K⁻¹. In special embodiments, materials having a linear expansion coefficient of 0.05×10⁻⁴ K⁻¹ or more, or of 2.0×10⁻⁴ K⁻¹ or more can also be employed. Examples for particularly suitable materials having a high linear expansion coefficient are phenyl methyl methacrylate having a linear expansion coefficient of 0.85×10⁻⁴K⁻¹ within a range of 25° C. to 80° C. and/or polycarbonate having a linear expansion coefficient of 0.7×10⁻⁴ K⁻¹ within a range of 25° C. to 80° C.

In a further preferred embodiment, the microarray to be integrated is magnetically fixed to a well. To this end, the areas forming the contact areas between well and microarray are developed magnetically.

Preferably, the microtiter plate is a linear arrangement of eight to twelve wells or a two-dimensional arrangement of arbitrary multiples thereof. Thus, the microtiter plate can be a two-dimensional arrangement of 8×12 wells or 16×24 wells.

Preferably, the wells have a rectangular, square and/or circular base.

Particularly preferably, the wells of the device according to the present invention are arranged in rows of eight, particularly cylindrical, wells which are also referred to as AT strips in the following or in a two-dimensional arrangement of 8×12=96 cylindrical wells, which are also referred to as AT microplate in the following.

The individual wells of the device according to the present invention preferably have at their bottom base a probe array or microarray for conducting array experiments. The size of the probe arrays employed depends on the size and geometry of the wells of the device according to the present invention. In case of cylindrical wells in a strip-shaped or two-dimensional arrangement having a base diameter of, for example, about 6.5 mm, probe arrays having a side length of about 4.5 mm×4.5 mm are preferably employed. In an arrangement of 384 parallel wells in form of a 24×16 well microplate and square base bottoms of the wells having a side length of about 3.6 mm, square probe arrays having a side length of about 3 mm are preferably employed. Further preferred dimensions of the biochips are about 2×2 mm to 10×10 mm.

In one embodiment of the present invention, the support element or the support for the probe molecules in the device according to the present invention is optically transparent and/or non-fluorescent in the region of the detection area. Detection area denotes the area of the support element where probe molecules are immobilized in predetermined regions.

In a preferred embodiment of the present invention, the probe molecules are applied on the support element directly, without the support element comprising a further basic element.

In other preferred embodiments, the probe molecules are applied on a preferably optically transparent and/or non-fluorescent chip, which in turn is firmly connected to a basic element that is preferably optically transparent and/or non-fluorescent at least in the detection area defined by the chip. Herein, the dimensions of the chip are smaller than the dimensions of the basic element. In this case, the support element is formed by the chip bearing the probe molecules together with the basic element.

In a preferred embodiment of the device according to the present invention, the base located opposite the detection area of the support element is also optically transparent and/or non-fluorescent in the region corresponding to the detection area.

In general, a probe array or microarray according to the present invention comprises a support allowing the formation of arrays with probes on its surface. Such a support can, inter alia, be manufactured from materials selected from glass, filters, electronic devices, polymers, metallic materials and the like and/or from optional combinations of said materials. Particularly preferably, the probe molecules are arranged on a rough or porous support surface. The support can, for example, have a porous membrane which the probes are applied on or are embedded in. Such a porous membrane can have a thickness of 100 nm to 5 μm, preferably of 200 nm to 2 μm or of 400 nm to 1 μm.

In one embodiment, the support element consists of optically transparent and/or non-fluorescent materials. Such materials can, for example, be glass, Borofloat 33 (for example available from Schott, Jena, Germany), silica glass, single-crystal CaF₂ (for example available from Schott), single-crystal silicon, phenyl methyl methacrylate, acryl and/or polycarbonate.

Aside from the optically transparent or non-fluorescent materials for the support element or the chip previously described, in a further embodiment of the present invention, optically non-transparent or optically opaque materials such as conventional filter, ceramic, metal, semimetal and/or synthetic materials are preferred for the support element or the chip. Thus, for example, nylon membranes specifically manufactured for DNA libraries can be employed as support materials. Silicon is a particularly preferred optically non-transparent material for the support element or for the chip. The use of optically non-transparent support materials is particularly preferred in case the detection of probe/target interactions on the array is conducted by means of dark field and/or reflection measurements and/or in case the light source is arranged above the biochip support.

Conventionally, the immobilized probe molecules on the support element are a substance library.

The substance libraries can be protein substance libraries, peptide substance libraries, and nucleic acid substance libraries. In the first instance, the protein substance libraries can be antibody, receptor molecule and membrane protein libraries. Conceivable peptide libraries are receptor ligand libraries, pharmacologically active peptide libraries and peptide hormone libraries.

Nucleic acid substance libraries are primarily DNA and RNA molecule libraries. Particularly preferably, ribosomal DNA sequences of microorganisms can be applied on the support element in case of DNA molecule libraries. Furthermore, they can be nucleic acid substance libraries for SNP analysis. Also conceivable are protein or nucleic acid substance libraries allowing a so-called expression profiling. A further alternative are combinatory substance libraries.

Here, the substance libraries are applied onto the support element in such a way that they contact the sample space of the wells. Thus, the support element is preferably characterized in that it has on its surface a detection area with a substance library.

Preferably, the support elements integrated in the device according to the present invention are so-called DNA chips. Such a DNA chip is, for example, a DNA library bound to a glass surface while unambiguously assigning the DNA sequences to predetermined regions of the surface.

In a further embodiment of the present invention, the device according to the present invention additionally comprises an optical system having a light source and a detector. Particularly preferably, light source and detector are arranged on opposite sides of the microtiter plate. Light sources and detectors suitable within the scope of the present invention are described in the following.

When using a staining method of the interaction that acts reactively enhancing, like immunogold/silver staining or the enzymatic precipitation of an organic precipitate, the detection can be conducted by means of simple absorption or reflection measurements, as opposed to the conventionally employed fluorescence measurements, so that the total cost for the device according to the present invention are very low.

Thus, the device according to the present invention is preferably employed in a detection method in which, as has been described above, the detection is conducted via a reaction leading to a precipitate at the array elements where an interaction between probes and targets has occurred. In the wells, interaction products in form of a precipitate will form on some array elements of the microarrays integrated therein due to the specific interaction of the sample or the target with the probes. Said interaction products have a different absorption coefficient compared to the pure substances. By means of suitable reactions, this effect can be considerably enhanced, as will be described in the following.

Preferably, the detection device comprises a camera, in particular a CCD or CMOS camera or similar cameras, which usually records the entire area of the probe array. Alternatively, scanning methods for the detection device for reading out the device according to the present invention can also be employed.

In special embodiments of the device according to the present invention, the detection device additionally comprises optics for illumination and imaging or reading out.

In a preferred embodiment, the device according to the present invention additionally comprises at least one light source. A light source within the scope of the present invention preferably ensures homogenous illumination of a support of the microarray. Particularly preferably, the light source is selected from the group consisting of lasers, light-emitting diodes (LED), banks of lamps and high-pressure lamps.

Aside from point light sources, light sources in form of illumination arrays can also be employed in the device according to the present invention. In this embodiment, homogenous illumination of the support can, for example, be ensured in that the light source comprises several diffusely emitting light sources, whose superimposition results in homogenous illumination. Thus, for example diffusely scattering LED, which are arranged in the shape of a matrix, enable homogenous illumination on short distances from the sample.

Homogeneity of illumination can also be achieved by means of correspondingly structuring the bottoms of the wells or the optionally present lid of the device according to the present invention. In this way, the bottoms of the wells or the lids of the device according to the present invention function as a light-scattering disc.

In case the microarray is integrated in the bottom of a well, the bottom of the chip support preferably is evenly transparent. With the use of an evenly transparent bottom without optical properties, the light source required for the transmission detection is preferably arranged below the biochip support, whereas the detection module is preferably arranged above the biochip support.

In case of a biochip support consisting of materials having optical properties, the arrangement of illumination and detection module can also be inverted. In this embodiment, the regions of the device according to the present invention that are located in the optical light path thus preferably consist of transparent to highly transparent materials of optical quality. Preferably, synthetic materials like polypropylene or polyethylene having a thickness of, for example, 0.1 mm to 1 mm are preferably suitable for this purpose.

In case of a biochip support consisting of optically non-transparent materials, both illumination and detection module are preferably arranged above the biochip support, i.e. on the side of the biochip support that is facing the reaction chamber, i.e. the interior of the wells.

Furthermore, the wells have a planarity of the base the microarray is located on that is sufficient for the preferably optical detection. Thereby, a simple optical detection from above or from below that is free of scattered light is ensured.

When conducting a fluorescence detection, the parts of the walls of the wells that are not located in the neighborhood of the probe array can also consist of stained or pigmented synthetic materials, for example of black polypropylene. Thereby, disturbing background signals can be avoided.

A further aspect of the present invention relates to a method for manufacturing a device for the simultaneous performance of microarray experiments for detecting a specific interaction between target and probe molecules on a microtiter plate whose wells each have an individual microarray, the microarray having probe molecules arranged in predetermined regions, comprising the following steps:
a) manufacturing of microarrays with probe molecules arranged in predetermined regions of the microarray, preferably in an assembly;
b) controlling the quality of the microarrays generated in step a);
c) selecting suitable individual microarrays and, optionally, releasing the selected microarrays from the assembly;
d) fixing the individual microarrays selected in step c) in wells of the microtiter plate; and/or
e) optionally filling up free regions or gaps or empty spaces between microarray and walls of the wells.

In the method according to the present invention, microtiter plate and individual microarrays are provided separately and are combined in a separate step to form a device for the simultaneous detection of microarray experiments, for example, in that the probe arrays are glued to a base of the well or the reaction tube. The advantage of the method according to the present invention consists in that the bioarrays can be manufactured, preferably in an assembly, for example on a wafer, in a manner that is independent of the microtiter plate and therefore of the biochip support. Subsequently to manufacturing the arrays, for example in an assembly, a quality control of the arrays can be conducted, according to which only those microarrays are selected for fixing or assembly in the microtiter plate that meet the requirements of the quality control.

As in the currently established production methods for bioarrays it is not possible to guarantee a 100% yield of flawless chips, the production method according to the present invention has the advantage that a higher yield of flawless biochip supports is achieved than by means of conventional methods, in which the bioarrays are either produced directly on the biochip support or on the microtiter plate or, however, a wafer having several bioarrays serves as base of a microtiter plate.

Preferably, in step a) of the method according to the present invention, several microarrays are produced, for example preferably at least 50, at least 100, at least 150 or at least 350, particularly preferably at least 114, at least 120 or at least 397 microarrays in a pool, for example on a wafer, a glass plate or an object support. Depending on the dimensions of the microarrays and the support plate, the number of microarrays can be limited, for example to about 80 microarrays in case of a conventional object support and to about 416 microarrays in case of a glass plate of 119.5 mm×75 mm. In this embodiment, it is further preferred that the quality control in step b) is conducted with the microarrays in the assembly, for example on the wafer. In this embodiment it is further preferred that the microarrays selected in step c) are located in the assembly, for example on the wafer, and are isolated or released from the assembly for fixing in the wells, for example by means of sawing them out of the assembly.

Preferably, the microarrays are integrated in a substantially continuous manner in the wells of the microtiter plate in step d) of the production method according to the present invention. Herein, the substantially continuous integration is particularly conducted as has been described above for the device according to the present invention.

The microarrays employed within the scope of the present invention having probes immobilized at defined sites can generally be generated or produced according to conventionally known methods. DNA chips are preferably produced by means of generally conventional spotting methods or by means of specific locally resolved synthesis methods. For production, alternative methods such as synthesis methods via a light-directed DNA synthesis can also be considered. Methods for producing probe arrays or chips, specifically DNA chips, are known to the person skilled in the art and are described, inter alia, in DE 197 06 570, EP 0 969 918 and WO 98/36827.

Preferably, the probe arrays are produced according to two basically different methods.

In one method, separately synthesized probes, for example oligonucleotides, are applied onto surfaces and are covalently or non-covalently linked thereto by usingautomats, so-called spotters, which ensure the site-specific deposition of minute amounts of liquids. The method operates serially. Each spot is individually equipped with the probe.

Alternatively, probe arrays are generated by means of site-specific in situ synthesis of the probes, for example the oligonucleotide probes. The synthesis is conducted simultaneously, for example in wafer scale. Suitable reagents for activating the array surface or suitable protecting groups for the probe synthesis on the array surface are known to the person skilled in the art.

Immobilizing molecules on the array surface can be conducted either specifically or unspecifically. The specific immobilization requires a selectivity of the interaction of specific chemical functions of the molecule to be immobilized with the surface of the substrate. An example of a specific, non-covalent immobilization is the binding of biotin-labeled nucleic acid to a substrate coated with streptavidin. Amino-modified nucleic acids can be specifically immobilized via the reaction of the amino group with an epoxide, a carboxy function, or an aldehyde. Preferably, the immobilization is conducted via a terminal phosphate group of the probe or of the monomer component of a biopolymer probe on an aminated surface.

The site-specific immobilization occurs via a multiplicity of mechanisms and chemical functions and can be both covalent and non-covalent. An example is the immobilization of nucleic acids on a substrate surface modified with poly-L-lysine, but also the immobilization of chemically non-modified nucleic acids on substrate surfaces that are epoxidized, aminated or occupied with aldehyde functions.

For depositing small amounts of material in provided places on a substrate for producing a probe array, which is inserted into the reaction tube according to the present invention, methods known to the person skilled in the art can be employed as well. A number of such methods is described, e.g. in D. J. Lockhart, E. A. Winzeler; Genomics, gene expression and DNA arrays; Nature, 405, pages 827-836, 2000.

Furthermore, the present invention provides an arrangement for the performance and analysis of microarray experiments for detecting a specific interaction between probe and target molecules. Said arrangement comprises a microtiter plate, wherein the wells of the microtiter plate each contain an individual microarray having probe molecules arranged in predetermined regions, in particular as described above, is integrated. A detector device is provided for recording a specific interaction between probe molecules arranged in predetermined regions of the microarray and target molecules.

Thus, an integrated analysis system is provided, in which the microtiter plate and the detector device are provided in an interacting manner. By means of the detector device, hybridization events can reliably be detected in the wells.

According to one advantageous embodiment of the arrangement, the microtiter plate is developed in such a way that the wells in the bottom region substantially have no surface topology or elevations. In particular, the microtiter plate is developed as described above within in the description of the device according to the present invention for the simultaneous performance of microarray experiments.

Preferably, the arrangement further has a processing device located on a microarray for processing a specific interaction recorded by means of the detector device on the basis of an externally selectively predeterminable, preferably validated, processing instruction. A desired operating mode of the arrangement can thus be predetermined externally, in particular by a user, for such a processing device. For instance, information as to under which experimental conditions (for example temperature, type of microarray used or substance to be examined, type of washing and buffer solutions to be used, degree of multiplexing, array layout, assignment table, threshold value table, parameters for processing like duration of the assay etc.) one or more microarray experiments are supposed to be conducted and/or analyzed on the microtiter plate can be provided for the arrangement in form of a processing instruction. Alternatively or complementarily, information as to which type of examination is supposed to be conducted can be provided for the arrangement in form of a processing instruction, for example which specifically selected examination, which can be conducted by means of the arrangement, is desired (for example an examination whether a patient, whose blood sample is examined, is suffering from disease A, B, or C). It is thus possible to predetermine externally a user-specific setting for a desired operation mode of the arrangement, namely either definitely for all future examinations to be conducted or merely with respect to the next examination to be conducted. In order to make such a selection, a user can, for example, insert a plug-in card containing a barcode into the arrangement or the microtiter plate can be equipped with a barcode, wherein the barcode that can be read by the arrangement can contain control information and/or the assignment to, for example, an assay protocol or a type of array, which can be contained in the arrangement or in the storage medium inserted by the user. Alternatively, the user can select an operation mode for the device, e.g. via a menu, or a user enters a numeric code for a specific desired operation mode via a keyboard. On the basis of such a code, a corresponding control routine can be located in the arrangement. Of all the routines conductible via the arrangement (which can, for example, all be stored on a storage medium of the arrangement, such as a database stored on a hard disk), the one control routine that is assigned to the control information entered by the user can be located unambiguously.

On the one hand, a processing instruction can be understood to denote that the entire code to be conducted for operating the arrangement as related to a selected application is entered externally. In this case, the entire control program is entered into the arrangement externally, so that the storage of the control code in the arrangement is dispensable.

On the other hand, processing instruction can be understood to denote that a sort of password or address is merely provided externally as a processing instruction, wherein the code to be conducted for operating the arrangement as related to a selected application is then contained in the arrangement itself in form of a database or software base. In this case, only information as to which control program is supposed to be conducted is entered into the arrangement externally, wherein the actual control code is stored in the arrangement.

Validated is particularly understood to denote that in case of multiple conducting of a specific experiment under identical conditions an identical or defined result is obtained.

Moreover, the present invention provides an arrangement for conducting and analyzing microarray experiments for detecting a specific interaction between probe and target molecules, said arrangement having at least one reaction tube in which a microarray having probe molecules arranged in predetermined regions of the microarray is integrated. The arrangement further comprises a detector device for recording a specific interaction between probe molecules arranged in predetermined regions of the microarray and target molecules. A processing device is provided for processing the interaction recorded by means of the detector device, based on an externally selectively predeterminable, preferably validated, processing instruction.

In particular, the reaction tube is developed as described in the International Patent Application WO 03/059516, whose relevant contents are hereby explicitly referred to.

In particular, the reaction tube has a shape and/or size that is typical for a laboratory reaction tube, wherein on one of its bases a support element is located having immobilized probe molecules arranged thereon in predetermined regions. The use of such a reaction tube for detecting specific interactions between molecular target and probe molecules offers the substantial advantage that the acquisition of additional devices or additional equipment for conducting the detection reactions is not required as the devices that are conventionally used in laboratories, in particular in biological laboratories, such as table centrifuges and pipettes, can be employed. It is a further advantage of such a reaction tube that it renders a separate incubation chamber superfluous as the reaction tube simultaneously serves as a hybridization chamber. In addition, the surface of the support having the probe molecules immobilized thereon is protected against contaminations and other disadvantageous external influences by the lid lock that is typical for conventional laboratory reaction tubes, for example the safe-lock lid lock of Eppendorf reaction tubes.

Within the scope of the present invention, laboratory reaction tubes of typical shape and size are understood to denote reaction tubes usually employed, in particular, in biological or molecular-biological laboratories as disposable reaction tubes, the standard type containing 1.5 ml. With reference to the major manufacturer, such laboratory reaction tubes are also referred to as Eppendorf tubes or “Eppis” (Hamburg, Germany). Thus, laboratory reaction tubes having a typical shape and size are offered by Eppendorf as standard reaction tubes or safe-lock reaction tubes. Of course, reaction tubes having a shape and size that is typical for laboratory reaction tubes, in particular for those by Eppendorf, by manufacturers like Greiner (Frickenhausen, Germany), Millipore (Eschbom, Germany), Heraeus (Hanau, Germany), and BIOplastics (Landgraaf, Netherlands), as well as by other manufacturers, may also be employed within the scope of the present invention. Examples of laboratory reaction tubes having a typical shape and size are shown in FIG. 14.

Within the scope of the present invention, laboratory reaction tubes of typical shape and size are, in particular, not understood to denote round-bottomed flasks or other flasks like Erlenmeyer flasks, glass beakers, or measuring cylinders.

Preferably, the reaction tube is distinguished from the aforementioned laboratory reaction tubes in that it has a support element, on which probe molecules are immobilized in predetermined regions, arranged on one of its bases. Such a support element having probe molecules immobilized in predetermined regions thereon will also be referred to as chip or affinity matrix in the following. The predetermined regions on the support will also be referred to as array elements in the following.

Despite the modification of a conventional laboratory reaction tube by means of incorporating such a chip, the reaction tube still has a shape and/or size that is typical for a laboratory reaction tube. The reaction tube according to the present invention has a rotationally symmetrical shape, in particular a cylindrical or substantially cylindrical shape. Of the shapes typical for conventional laboratory reaction tubes and therefore conceivable for the reaction tube within the scope of the present invention, a conical shape deviant from the cylindrical basic shape is also comprised, wherein the tapering preferably proceeds in the direction toward the affinity matrix. Further, typical shapes are combinations of cylindrical or substantially cylindrical regions and conical regions (see, inter alia, FIGS. 14 to 18). Due to the shape and size that is typical for laboratory reaction tubes, a preferred reaction tube within the scope of the present invention is particularly compatible with conventional table centrifuges, such as centrifuges made by manufacturers like Eppendorf or Heraeus, i.e. the reaction tube is preferably suitable for centrifugation in conventional table centrifuges. Typical maximum external diameters of standard laboratory reaction tubes and therefore also of the reaction tube preferred within the scope of the present invention are within a range of 0.8 cm to 2 cm, preferably 1.0 cm to 1.5 cm, and particularly preferably 1.1 cm to 1.3 cm. Further preferred external diameters are up to 0.9 cm, up to 1.2 cm, up to 1.4 cm, up to 1.6 cm and up to 1.7 cm. Typically, the height of the laboratory reaction tube preferred within the scope of the present invention is 1.5 cm to 5.0 cm, preferably 2.0 cm to 4.0 cm, particularly preferably 2.5 cm to 3.5 cm, and most preferably 2.8 cm to 3.2 cm. Further preferred heights are up to 2.6 cm, up to 2.7 cm, up to 2.9 cm, up to 3.0 cm, up to 3.1 cm, up to 3.3 cm, and up to 3.4 cm. In special embodiments, the height can also be 1.0 cm or more. The reaction tube preferred within the scope of the present invention can be centrifuged in conventional table centrifuges and can thus, for example, be employed in conventional table centrifuges, such as a standard table centrifuge with standard rotor by Eppendorf, as well as in conventional racks and holders for reaction tubes, such as a tube rack by Eppendorf. For introducing the sample to be examined and other reagents required for performing the detection reaction into the reaction tube, conventional pipettes or syringes, such as variable and fixed volume pipettes by Eppendorf, can be used.

Within the scope of the present invention, a support element or support is understood to denote a solid body on which the probe array is set up. The support element having the probes arranged thereon will also be referred to as chip in the following and can, in special embodiments of the present invention, further comprise a basic element on which the chip is arranged.

The support element can be arranged in the reaction tube in that it is simply inserted or clamped in, preferably in that the chip surface is designed in such a way that it can be inserted or clamped into a laboratory reaction tube, for example into its lid, so that it fits snugly. Alternatively, a base of the laboratory reaction tube is flattened in such a way that the support element can be attached thereon. If required for technical reasons, the support or the chip can also be installed in the side walls of the reaction tube according to the present invention.

However, in an advantageous embodiment the base, preferably the bottom, of the laboratory reaction tube has a recess for receiving the support. The support or chip can, for example, be glued and/or clamped and/or screwed and/or welded, in particular by means of laser welding, and/or engaged into said recess from the inside and/or from the outside. In said embodiments, the reaction tube has a shape and size typical for a laboratory reaction tube and an opening formed as a frame for receiving the affinity matrices, in particular the surface-bound substance libraries. Examples of such embodiments of the reaction tube are given in the FIGS. 15 to 18. Aside from the variants shown therein, further combinations of the type of attachment of the support are of course also conceivable.

Incorporating the support or chip from the inside has the advantage that the support or chip cannot be pushed out of its attachment towards the outside, not even as the internal pressure increases, for example, in case of use in a centrifuge or in case of heating the sample liquid up to temperatures near the boiling point.

Clamp connections or screw threads or notches provide a force-fit and liquid-proof connection between reaction tube and support or chip. Such variants combine the advantages of inserting the support or chip into the reaction tube from the inside with those of a simplified installation. A further connecting joint, for example the clamp connection, as well as the larger number of components have a disadvantageous effect.

The manufacture of a reaction tube as previously described usually starts out from an injection-molded standard laboratory reaction tube, in particular by one of the previously mentioned manufacturers. Said reaction tube is trimmed at the bottom and is then recast in a device especially provided for this purpose. Such a method is in particular suitable for lower numbers of pieces. In case of larger numbers of pieces, it is advantageous to directly injection-mold the reaction tube to form one of the previously mentioned embodiments.

In order to protect the affinity matrix against impurities from outside, it is advantageous to stretch/glue a protecting foil over/to the bottom of the reaction tube, which will be removed immediately before the reaction tube is used.

Typically, the base, on which the support element having the probe molecules immobilized in predetermined regions thereon is arranged, is the bottom of the reaction tube according to the present invention.

Alternatively, the support can also be attached in the lid of the reaction tube as described above. Incorporating the support element or the chip area in the lid of the reaction tube is particularly advantageous in cases where the affinity matrix is sensitive to the conditions in one or more of the reaction steps for preparing and/or conducting the detection reaction. In this embodiment of the reaction tube, such reaction steps can be conducted in the upright reaction tube, whereby the affinity matrix or the chip is not contacted with the reaction and sample solutions and is thus protected. For conducting the detection reaction, the reaction tube is then turned upside down to stand on its lid, so that the sample is contacted with the surface-bound probes. In this manner, the thermal and chemical strain on the affinity matrix or on the chip is reduced.

Preferably, the support element of the reaction tube as previously described is optically transparent and/or non-fluorescent in the region of the detection area. The detection area denotes the region of the support element where probe molecules are immobilized in predetermined regions. In a preferred embodiment of the present invention, the probe molecules are directly applied onto the support element without the support element comprising a further basic element.

In other preferred embodiments, the probe molecules are applied on a preferably optically transparent and/or non-fluorescent chip, which in turn is firmly connected to a basic element that is preferably optically transparent and/or non-fluorescent at least in the detection area defined by the chip. Herein, the dimensions of the chip are smaller than the dimensions of the basic element. In this case, the support element is formed by the chip bearing the probe molecules together with the basic element.

In a preferred embodiment of the reaction tube as previously described, the base located opposite the detection area of the support element is also optically transparent and/or non-fluorescent in the region corresponding to the detection area.

In general, a probe array according to the present invention comprises a support allowing the formation of arrays with probes on its surface. Such a support can, inter alia, be manufactured from materials selected from the group consisting of glass, filters, electronic devices, polymers, metallic materials and the like as well as of optional combinations of said materials.

The material of the container of the reaction tube usually corresponds to the materials that are conventionally used for laboratory reaction tubes and is, for example, selected from the group consisting of glass, glass ceramics, plastic-coated glass and synthetic materials or organic polymers like polypropylene, polyethylene, polystyrene, polycarbonate, PVC, polymethylmethacrylate, silicone plastic, rubber, polytetrafluorethylene and/or nylon. Metals, in particular stainless steels, platinum and/or aluminum are also conceivable for special embodiments.

Preferably, the reaction tube as previously described further has a size that is typical for a laboratory reaction tube. Typical filling volumes lie within a range of 100 μl to 2.5 ml; they can, however, be higher or lower in special embodiments. Particularly preferably, the reaction tube has a filling volume that is conventional for a standard Eppendorf tube of up to 1.5 ml. Further preferred filling volumes are up to 0.4 ml, up to 0.5 ml, up to 0.7 ml, up to 1.0 ml, or up to 2.0 ml.

Again, a main aspect of an arrangement according to the present invention is the predetermination, externally provided and selected from a variety of possibilities, of the mode of controlling and/or evaluating an experiment on the part of the processing device, which is conducted on the basis of the processing instruction.

The previously described arrangements can be equipped with an interface device, wherein the processing instruction can be externally predetermined by means of the interface device. Such an interface device can be a plug-in position, into which a medium containing the processing instruction (for example a magnetic card or a barcode) can be inserted in order to enter the processing instruction into the arrangement. Such an interface device can alternatively be a keyboard or a touchscreen, by means of which a desired processing instruction can be entered by a user. The interface device can also be a USB interface, via which the processing instruction can be transmitted.

Primarily, the interface device can be a graphical user interface (GUI) for externally predetermining the processing instruction by a user. Such a GUI can, for example, have a keyboard and a computer mouse, by means of which a desired operation mode can be adjusted via a monitor.

Alternatively, the interface device can be equipped for receiving and reading out a storage medium that can be externally inserted and on which the processing instruction is stored. Such a storage medium can, for example, be a diskette, a magnetic card, a noncontact chip card, an RFID tag or a device containing a barcode.

The detector device can comprise an optical detection device, in particular a camera for optically reading out a specific interaction. As an alternative to an optical readout, an electrical readout method can also be employed, which can, for example, be based on the alteration of the electrical properties (for example the impedance) of an analyte, which may vary in case of a hybridization event. The setup of the detection device can be developed as described in the International Patent Application WO 03/059516, whose relevant contents are hereby explicitly referred to.

The camera can be a CCD (charge-coupled device) camera, i.e. a charge-coupled circuit.

In particular, the camera can be manufactured by means of CMOS technology, furthermore particularly in form of a monolithically integrated circuit manufactured by means of silicon technology. Thereby, miniaturization of the arrangement is enabled.

The detector device can have imaging optics between the camera and the microarray. Such imaging optics may contain one or more optical elements like, such as lenses, shields, mirrors, beam splitters etc. in order to ensure optimal imaging of sensor events onto the camera. Thereby, the detection sensitivity of the arrangement can be improved.

The detector device can comprise a light source, wherein the light source can be installed for homogenously illuminating the microarray. Such a light source can be selected from the group consisting of a laser, a light-emitting diode (LED), a bank of lamps, and a high-pressure lamp.

Furthermore, a liquid supply device for introducing a liquid into the wells of the microtiter plate can be provided. A liquid supply device can be provided for introducing a liquid into the at least one reaction tube. Such a liquid supply device can be developed as pipetting device that is capable of feeding and mixing definable amounts of one or more liquids that are, for example, required for conducting a hybridization or a PCR reaction or in order to feed analyte liquids in a directed manner.

Such liquid supply devices or liquid handling devices are described in the prior art and comprise, inter alia, dispensing and aspirating devices as well as supply containers for washing solutions, detection solutions, substrates and the like. The supply containers can be tempered according to a conventional method. In particular, the supply containers are connected via hoses to a sample distribution arm or head which is preferably movable in xyz-direction and takes over the parallel, for example by means of a multi-channel adapter and/or serial distribution of samples, for example into individual wells of the microtiter plate device according to the present invention. It is, however, also conceivable that the sample distribution head is movable in less than three dimensions and the movement in the remaining dimensions is conducted by microtiter plates and/or supply containers. The sample distribution head can contain a jet or air supply. By means of the latter, (tempered) air or another suitable gas can be blown on the arrays in case a drying step is required.

The liquid supply device preferably withdraws a defined and selectable liquid out of usually several liquids stored in an optionally tempered supply container and transfers said liquid to a corresponding well.

Furthermore, a device for liquid discharge can also be provided, which preferably discharges a defined and selectable liquid, in particular the entire liquid, from a well and, optionally, into a container, for example a waste container. Such liquid discharge devices are also described in the art.

By means of a temperature adjusting device, a temperature of each of the wells of the microtiter plate can be adjusted. A temperature adjusting device can also be installed for adjusting a temperature in the reaction tube. A temperature adjusting device can additionally extend the functionality of the integrated system according to the present invention for conducting and analyzing an experiment. By means of predetermining a temperature in a directed manner, the speed of physical, chemical, and biochemical reactions and interactions can be exactly predetermined and optimized. In particular, a conventional tempering device for microtiter plates can be employed, which preferably also enables temperature gradients and temperature steps and, particularly preferably, an alteration in temperature that is required for the purposes of the PCR.

By means of a moving device, the detector device and/or the microarray(s) and/or the liquid supply device and/or the liquid discharge device and/or the temperature adjusting device can be moved in any desired predeterminable direction. Each of the mentioned components can be moved in relation to any other of the components in any desired direction. For instance, the detection device can be moved as related to the microtiter plate in a plane that is parallel to the microtiter plate in order to scan the individual sensor fields in a two-dimensional manner. Furthermore, the distance between the detection device and the microtiter plate can be altered by moving and thus be adjusted to a desired value.

In a further embodiment, the detector device is rigid and the microtiter plate is movable in a plane that is parallel to the detection device.

In a further embodiment, the microtiter plate and/or the microarray(s), for example at a position between the wells or at one of the edges of the microtiter plate and/or of the microarray(s), preferably contain(s) a marker or a label, for example a detectable unit as described below, a recess, a drilling, a hole, in particular a through hole, a reflecting element, a reticule in front of a suitable background and the like. The marker ensures exact positioning of the microtiter plate and/or the microarray(s) relative to the detector. In this embodiment, the positioning is preferably conducted step by step, wherein in one step a detection of the position of the marker occurs and then the detection result, the actual value, is compared to a desired value and, if necessary, concomitantly a correction of the position of the microtiter plate and/or the microarray(s) as related to the detector is performed. Thereby, the detection of the marker element and the subsequent correction of the position of the microtiter plate and/or the microarray(s) relative to the detector is preferably conducted automatically, for example controlled by a suitable software.

According to the present invention, a method is also provided for processing a specific interaction between target molecules and probe molecules arranged in predetermined regions of a microarray that has been recorded by means of an arrangement for conducting and analyzing microarray experiments. In said method, a specific interaction recorded by means of a detector device is processed on the basis of an externally selectively predetermined processing instruction.

According to the present invention, a computer-readable storage medium is also provided on which a program is stored for processing a specific interaction between target molecules and probe molecules arranged in predetermined regions of a microarray that has been recorded by means of an arrangement for conducting and analyzing microarray experiments, wherein in the program, in case it is conducted by a processor, the method is performed with the features described above.

Furthermore, a program element is provided, on which a program for processing a specific interaction between target molecules and probe molecules arranged in predetermined regions of a microarray that has been recorded by means of an arrangement for conducting and analyzing microarray experiments is stored. In the program, in case it is conducted by means of a processor, the method is performed with the characteristics described above.

Thus, the method according to the present invention can be implemented both by means of a computer program, i.e. a software, and by means of one or more specific electrical circuits, i.e. in hardware, or in any hybrid form thereof, i.e. by means of software and hardware components.

Again, it is a main aspect of said method that a specific interaction that has been recorded by means of a detector device can be processed on the basis of an externally selectively predetermined processing instruction. In other words, the method operates and controls an arrangement according to the present invention in such a way that the way of operating the arrangement and the way of evaluating the measured data can be adjusted externally and can be selected from a variety of options. Via a storage medium, a user can enter code for the method into the arrangement which will then conduct such a method. Alternatively, the user merely specifies in an unambiguous manner, through the processing instruction, which control program already contained on a storage medium of the arrangement is supposed to be conducted by providing an address, a flag, an identification number or any other code as processing instruction, which unambiguously enables the arrangement to identify which control program is to be accessed.

On the basis of the externally selectively predetermined processing instruction, a selective processing according to one microarray experiment that has been selected from a variety of possible microarray experiments can be conducted. The arrangement can be capable of conducting a specified number of different experiments (for example a first experiment for examining a sample for disease A, a second experiment for examining a sample for disease B, and a third experiment for examining a sample for disease C). The processing instruction can contain information as to which specific experiment is supposed to be conducted now (for example the first experiment for examining a sample for disease A).

On the basis of the externally selectively predetermined processing instruction, selective processing and analysis can be conducted according to at least one selected experimental parameter for the microarray experiment performed. In other words, the processing instruction can predetermine experimentally adjustable parameters, for example temperature, type of microarray used or substance to be examined, type of washing and buffer solutions to be used, degree of multiplexing, array layout, assignment table, threshold value table, parameters for processing like duration of the assay etc.

On the basis of the externally selectively predetermined processing instruction, selective validated processing according to a special microarray experiment can be conducted. Validated is understood to denote that in case of repeated performance of a specific experiment under respectively identical conditions a respectively identical result is obtained.

Providing the arrangements according to the present invention enables (i) a standardized development of tests based on microarrays, i.e. multiparameter analyses on the basis of surface-bound substance libraries, (ii) a standardized validation of tests based on microarrays, (iii) a simple performance or handling of a microarray-based and optionally validated test, in particular at any desired place, and/or (iv) the performance of an unlimited number of microarray-based and optionally validated tests in one device.

In particular, this is achieved by means of uniting preferably all process steps of test and evaluation in one arrangement or one device, which is preferably controlled by means of a standard test-specific data record.

In the following, preferred embodiments for providing or handling the arrangements of the present invention for conducting and analyzing microarray experiments or the computer-readable storage medium of the present invention or the program element of the present invention will be described:

When developing a microarray-based test for the arrangements of the present invention for conducting and analyzing microarray experiments, the arrangements are usually programmed independently and a software evaluation is conducted manually. In this manner, a test-specific data record is established that contains the parameters for processing and evaluating or analyzing the array experiments. The data record developed is preferably validated together with the chemicals, microarrays, in particular in the microtiter plate format according to the present invention, assay conditions etc. that are employed.

For handling the arrangements according to the present invention, the preferably validated data record is usually transferred once to the arrangement according to the present invention, for example by means of a storage chip, optionally having a USB connection. The arrangement according to the present invention preferably stores said data record in a database.

Subsequently to equipping the arrangement according to the present invention with microarrays, preferably in the inventive microtiter plate format AS, and with the reagents required for the reaction, which are preferably provided in form of a kit, the preferably diagnostic test can be performed. Preferably, said test is performed automatically.

Preferably, the arrangement recognizes which data record is required for conducting the array test from an identification number of the microarrays employed, preferably in the microtiter plate format according to the present invention.

Thus, for marketing a microarray-based assay having the objects according to the present invention it is merely required to provide, preferably once only, a data record that is assigned to the experiment to be conducted and subsequently, as with any one-parameter test, to deliver a kit consisting of microarrays, preferably in the microtiter plate format according to the present invention, and required chemicals. The user provides the arrangement with the components of the kit, optionally with instructions delivered with the kit, adds the samples to be analyzed and starts processing. With the aid of the assigned data, the arrangement according to the present invention conducts the test including evaluation and provides the user with a diagnostic recommendation, in case the test is a diagnostic test.

A kit as mentioned above can comprise hybridization buffers such as 6× SSPE, 2×MES, 3DNA and/or PBS; blocking reagents such as casein, milk powder, fetal bovine serum, herring sperm DNA, wherein said reagents are preferably dissolved in a suitable buffer; washing buffers such as 2×SSC with SDS or Triton, 2×SSC, 0.2×SSC and/or PBS; enzyme buffers such as the previously mentioned hybridization buffers; enzyme substrate solutions such as TMB in a suitable buffer, for example citrate buffer, for the enzymatic precipitation of an organic molecule and/or a silver solution for the silver precipitation of an inorganic precipitate; PCR master mixes; sample lysis solutions; denaturation solutions and/or renaturation solutions.

The arrangements according to the present invention enable the automatic performance of complex multiparameter analyses, in particular of diagnostic analyses, by means of combining hardware, software, and microarrays, preferably in the microtiter plate format according to the present invention. The arrangements according to the present invention take over the tasks of sample multiplexing, of assigning analyte data to result data, for example of patient data to diagnoses, of processing the samples and/or of fully automatic evaluation. The arrangements according to the present invention can process an unlimited number of different analytic, particularly diagnostic, problems. For instance, the arrangements according to the present invention automatically recognize the problem to be solved from an identification number, like a barcode, of the microarray or the microtiter plate according to the present invention with microarrays arranged therein and correspondingly conduct the analysis. The number of problems can be extended without limitation. Of course, the arrangements according to the present invention can also be operated manually for developing tests, in particular diagnostic tests.

In detail, one or more of the following characteristics can be implemented in the arrangements according to the present invention:

Automatic Recognition of the Problem to be Solved:

The microarrays or the device according to the present invention comprising a microtiter plate having microarrays integrated therein are labeled with an identification number (ID). By means of reading said ID, for example via a barcode, the protocol for processing the assigned test is loaded in a database. The protocol contains, for example, specific input parameters for the test; the degree of multiplexing; the directory of the surface-bound substance library, i.e. the array layout; an assignment table and/or a threshold value table.

Specific input parameters are understood to denote, for example, use-by dates of the hybridization and washing solutions, batch numbers, patient ID, dilutions and the like. A part of said specific input parameters can also be stored in a database. For instance, the supply container of the washing solutions can be equipped with a barcode. When the container is put into the device, said barcode is read out, the corresponding data record from a database is read out and utilized.

Assignment to Diagnostic Information:

Preferably, the software of the arrangement according to the present invention is capable of linking the data of the patient samples, preferably on a patient sample plate, with the data of a microarray or of the device according to the present invention comprising a microtiter plate having microarrays integrated therein and thus avoiding errors when assigning test results to patient samples. This can be conducted by means of reading an ID on the patient sample plate or by means of manual input.

Multiplexing or Degree of Multiplexing:

It is possible to provide arrays with different analytic problems. Thus, different PCRs with different sets of primers in different wells can be conducted with one patient sample. In the arrangement according to the present invention, the samples can then be incubated in one or more wells of the microtiter plate with the respective microarrays integrated therein. Subsequently, the analysis data can be linked by means of a software.

In order to determine the HLA type of a patient, for example, one PCR reaction can be conducted in a PCR microtiter plate in each of five separate wells of the device according to the present invention, each with a specific set of primers for the genotypes HLA A, B, C, D, DR, and DQ. The analysis of the PCRs is conducted subsequently in a well of a microtiter plate according to the present invention having microarrays integrated therein, which contains a microarray for the parallel analysis of all five genotypes. The assignment of the five wells of the PCR microtiter plate containing one monoplex PCR each to a multiplex analysis in a well of the microtiter plate according to the present invention is implemented via a corresponding assignment table.

Processing:

All processing steps such as sample transfer, incubation, washing, staining etc. are preferably conducted automatically in the arrangement according to the present invention.

Evaluation:

After processing is completed, the wells of the microtiter plate respectively having microarrays integrated therein are preferably guided across an imaging evaluation unit in a sequential manner. The gray values are preferably analyzed automatically by a software and are evaluated with the aid of an assignment and threshold value table. The results are made available to the user and can optionally be transferred to an LIMS (laboratory information management system) via standardized interfaces.

Extension of the Data Sets:

By means of supplementing a database, any desired number of tests can be taken over into the arrangement according to the present invention. The database can be supplemented, for example, via a so-called USB stick or via the internet. In this way, tests can also be modernized or extended.

Retraceability:

By means of the preferably computer-controlled operation, the respective conditions for each test conducted can be retraced.

With reference to FIG. 7, an arrangement 1000 for conducting and analyzing microarray experiments for detecting a specific interaction between probe and target molecules according to one embodiment of the present invention will be described in the following.

The arrangement 1000 contains a microtiter plate 1001, wherein in wells 1002 of the microtiter plate 1001 an individual microarray 1003 having probe molecules 1004 arranged in predetermined regions of the microarray 1003 is integrated.

A CCD camera 1005 is provided as detector device and is provided for recording a specific interaction between probe molecules 1004 arranged in predetermined regions of the microarray 1003 and target molecules (not shown).

The arrangement 1000 further contains a processing device developed as microprocessor 1006 (central processing unit, CPU) that is provided for processing the specific interaction recorded by means of the CCD camera 1005 on the basis of an externally and selectively predeterminable validated processing instruction. The CPU 1006 controls the arrangement 1000 and processes detected signals on the basis of the processing instruction provided by the user or by the manufacturer, which will be described in more detail in the following.

The processing instruction is provided to the arrangement 1000 via a magnetic card 1007, which is plugged into a plug-in device for magnetic cards 1008 as interface device. On the magnetic card, an identification number is stored that is read out by a read-out device for magnetic cards 1009. Said identification number is entered into the CPU 1006, which determines an operating program identified thereby that is stored on a hard disk 1010. The CPU 1006 accesses said program on the hard disk 1010 and, on the basis of the information contained therein, evaluates the data measured by the CCD camera 1005. Furthermore, the CPU 1006 is capable of controlling the experimental procedure of the experiment and the basic conditions of the experiment by means of the pertinent operating program.

The detector device has imaging optics between the CCD camera 1005 and the microarray 1003 in form of a converging lens 1011.

The detector device further comprises a light-emitting diode 1012 as light source for substantially homogenously illuminating the microarrays 1003.

Furthermore, a pipetting device 1013 that can be controlled by means of the CPU 1006 is provided as liquid supply device for introducing a liquid into wells 1002 of the microtiter plate 1001.

Moreover, a thermostatic unit 1014 that can be controlled by means of the CPU 1006 is provided, which is integrated in a retaining device 1015 for receiving the microtiter plate 1001. The thermostatic unit 1014 is installed for adjusting a temperature for each of the wells 1002 of the microtiter plate 1001. Said adjustment is conducted on the basis of the processing instruction.

The CCD camera 1005 can be moved by means of a moving device 1016. Furthermore, the pipetting device 1013 can be moved by means of the moving device 1016.

If the magnetic card 1007 is plugged in the plug-in position 1008, the reading device 1009 reads out a processing instruction from the magnetic card 1007. On the basis of said externally selectively provided information, the CPU 1006 then controls the tempering device 1014 and the pipetting device 1013 in order to conduct an experiment according to the processing instruction. Measurement data recorded by the CCD camera 1005 are then evaluated by the CPU 1006 according to the processing instruction.

A further aspect of the present invention relates to the use of a device according to the present invention as previously described or of the arrangements according to the present invention as previously described in a method for detecting the specific interaction between molecular probe and target molecules comprising the following steps:
a) interaction of the target with the probes arranged in predetermined regions (array elements) of the microarray; and
b) detecting the interaction.

Usually, the target molecules to be detected are labeled with a detectable marker. In the method according to the present invention, detection is preferably conducted in that the bound targets are equipped with at least one label detected in step b).

The label, which is coupled to the targets or to the probes, preferably is a detectable unit or a detectable unit coupled to the targets or the probes via an anchor group. The method according to the present invention is very flexible with respect to the possibilities of detection or labeling. Thus, the method according to the present invention is compatible with a multiplicity of physical, chemical or biochemical detection methods. It is the only prerequisite that the unit or structure to be detected can be directly coupled to a probe or a target, for example an oligonucleotide, or linked via an anchor group that can be coupled with the oligonucleotide.

The detection of the label can be based on fluorescence, magnetism, charge, mass, affinity, enzymatic activity, reactivity, a gold label and the like. The label is preferably based on the use of fluorophore-labeled structures or components. In connection with the fluorescence detection, the label can be any optional dye that can be coupled to targets or probes during or after their synthesis. Examples are Cy dyes (Amersham Pharmacia Biotech, Uppsala, Sweden), Alexa dyes, Texas Red, fluorescein, Rhodamin (Molecular Probes, Eugene, Oreg., USA), lanthanides like samarium, ytterbium and europium (EG&G, Wallac, Freiburg, Germany).

Aside from fluorescence markers, the use of luminescence markers, metal markers, enzyme markers, radioactive markers and/or polymeric markers as label or detection unit that is coupled with the targets or the probes is also possible within the scope of the present invention.

Likewise, a nucleic acid detectable by means of hybridization with a labeled reporter can also be used as label (tag) (sandwich hybridization). Various molecular-biological detection reactions like primer extension, ligation and RCA are employed for detecting the tag.

In an alternative embodiment of the method according to the present invention, the detectable unit is coupled to the targets or the probes via an anchor group. Preferably used anchor groups are biotin, digoxigenin and the like. The anchor group is converted in a subsequent reaction with specifically binding components, for example streptavidin conjugates or antibody conjugates, which themselves are detectable or trigger a detectable reaction.

By using anchor groups, converting the anchor groups to form detectable units can be conducted before, during or after adding the sample containing the targets or, optionally, before, during or after cleaving a selectively cleavable bond in the probes. Such selectively cleavable bonds in the probes are, for example, described in the International Patent Application WO 03/018838, whose relevant contents are hereby explicitly referred to.

According to the present invention, labeling can also be conducted by means of an interaction of a labeled molecule with the probe molecules. For instance, labeling by means of hybridization of an oligonucleotide labeled as previously described can be conducted with an oligonucleotide probe or an oligonucleotide target.

Further labeling methods and detection systems suitable within the scope of the present invention are, for example, described in Lottspeich and Zorbas, Bioanalytik, Spektrum Akademischer Verlag, Heidelberg, Berlin, 1998, chapters 23.3 and 23.4.

In a particularly preferred embodiment of the method according to the present invention, detection methods are employed that yield as a result an adduct having a specific solubility product which leads to a precipitation. For labeling, in particular substrates or educts are employed which can be converted to form a product that is hardly soluble and usually stained under the usual conditions of a detection method. In this labeling reaction, for example, enzymes can be used which catalyze the conversion of a substrate to a hardly soluble product. Reactions suitable for leading to a precipitation at the array elements as well as possibilities for the detection of the precipitate are, for example, described in the International Patent Application WO 00/72018 and in the International Patent Application WO 02/02810, the relevant contents of which are hereby explicitly referred to. In the detection method according to the present invention, as described in WO 02/02810, the chronological sequence of a precipitate formation at the array elements is, in particular, detected.

In a particularly preferred embodiment of the method according to the present invention, the bound targets are thus equipped with a label catalyzing the reaction of a soluble substrate or educt to form a hardly soluble precipitate at the array element where a probe/target interaction has occurred or acting as a crystal nucleus for the conversion of a soluble substrate to form a hardly soluble precipitate on the array element where a probe/target interaction has occurred.

In this manner, the use of the method according to the present invention allows the simultaneous qualitative and quantitative analysis of a multiplicity of probe/target interactions, wherein individual array elements having a size of <1000 μm, preferably of <100 μm and particularly preferably of <50 μm can be implemented.

The following Table I gives a survey of a number of reactions to be considered that are suitable for leading to a precipitate at the array elements where an interaction between target and probe has occurred:

TABLE 1

| Catalyst or | |
|---|---|
| crystal nucleus | Substrate or educt |
| Horseradish | DAB (3,3′-diaminobenzidine) |
| peroxidase | 4-CN (4-chloro-1-naphthol) |
| | AEC (3-amino-9-ethylcarbazol) |
| | HYR (p-phenylenediamine-HCl and pyrocatechol) |
| | TMB (3,3′,5,5′-tetramethylbenzidine) |
| | naphthol/pyronine |
| Alkaline | bromochloroindoylphosphate (BCIP) and |
| phosphatase | nitrotetrazolium blue (NBT) |
| Glucose | t-NBT and m-PMS |
| oxidase | (nitrotetrazolium blue chloride |
| | and phenazine methosulfate) |
| Gold | silver nitrate and silver tartrate |
| particles | |

The detection of probe/target interactions via insoluble precipitates is described in WO 02/02810.

The optical detection of probe/target interactions, in particular of kinetically proceeding signal enhancing reactions, is preferably conducted by means of recording modulations of specific optical parameters, in particular of transmission, reflection, dispersion, diffraction and interference. Thus, detecting the presence of a precipitate on an array element in an embodiment of the present invention is conducted by means of reflection, absorption or diffusion of a light beam, preferably a laser beam or a light-emitting diode, that is caused by the precipitate. Due to its granular form, the precipitate modifies the reflection of a light beam. Furthermore, the precipitate leads to a strong diffusion of light, which can be recorded by means of conventional detection devices. In case the precipitate, such as a silver precipitate or an organic precipitate, appears as a dark surface, the absorption of light can also be detected and recorded.

For instance, the detection of the regions enhanced by the specific reaction can be conducted by means of a simple optical setup in transmitted light, i.e. contrast by shading, or incident light, i.e. contrast by reflection. The detected intensity of the shaded region is directly proportional to the density of occupation with labels, such as gold particles or enzymes, and the crystal nucleation state of the particles.

Also preferably, detecting precipitate formations on the detection area or on the support occurs in a dark field, i.e. alterations of the dispersing properties of the detection area or of the support are detected.

Furthermore, a preamplification of the material to be analyzed is not necessary in all of the previously described embodiments of the method according to the present invention. From the sample material extracted from bacteria, blood or other cells, specific partial regions can be amplified and hybridized to the support with the aid of a PCR (polymerase chain reaction), in particular in the presence of the device according to the present invention or of the substance library support as described in DE 102 53 966. This constitutes a considerable reduction of labor expenditure.

The following examples serve to illustrate the present invention and are not to be understood as limiting.

### EXAMPLES

### Example 1

### Manufacturing a Device According to the Present Invention for Conducting Microarray Experiments in Parallel

In this example, transparent 8-well ELISA strips (i.e. strips having eight interconnected individual wells) by Greiner Bio-one (Art. No. 762070) that are made of polystyrene and have a circular planar bottom base and a filling volume of 50-350 μl per well are employed as basic bodies for producing the wells having an integrated probe array. The bottom base has a diameter of about 6.5 mm. Each of the eight wells of the arrangement has its own probe array. The probe arrays introduced into the individual wells having a cylindrical geometry have external dimensions of 4.5 mm×4.5 mm as well as an active surface of 4.2 mm×4.2 mm that is occupied with the respective substance library (see FIG. 3).

Introducing the eight probe arrays into the individual wells of the device is conducted by means of gluing them to the bottom base of the wells in an exactly positioned manner. To this end, a small amount of an adhesive of the type NOA76 (Norland, N.J., USA) is applied onto the non-active side of the array support with the aid of a compressed air sprayer, which allows finest dosage. Subsequently, the arrays are inserted into the well and pressure is exerted for 3 s. In order to further fix the probe arrays to the bottom base of the wells, the AT strip produced in this way is cured for 7 s with light having a wavelength of about 300 to 450 nm (for example Sol 2, Dr. Hoenle AG, Germany; light having a wavelength smaller than 300 nm is filtered through suitable filters).

Subsequently, the free areas between the biochip and the wall of the well are filled up with NOA76 adhesive with the aid of the compressed air sprayer and are once more cured for 1 min under the influence of light, as described above.

The prepared AT strips can be inserted into standard microtiter plate frames having dimensions of 127.76 mm×85.48 mm (for example Greiner, Bio-one), which allow an easy handling of the strips in standard devices for microtiter plates. Herein, twelve of the 8-well AT strips will fit into such a standard microtiter plate frame (see FIG. 4).

### Example 2

### Serological Test using a Device According to the Present Invention for Conducting Microarray Experiments in Parallel

In this example, the arrays of the strips according to the present invention consist of a library of antibodies in a layout of 19×19 spots; the library consists of two different antibodies (human IgG and anti-human IgG) in nine different concentrations each, three control antibodies and the biotin marker molecules that are required for evaluation and analysis.

Antibodies and marker molecules are applied onto a glass substrate surface in standard object support format with the aid of a needle spotting method; moreover, the antibodies are present in a PBS buffer mixed with 20 mM trehalose. The spotting method ensures the parallel production of up to 80 individual glass chips on the object support. After spotting, the glass substrate is split into 80 individual chips of the size 4.5 mm×4.5 mm having a prepared antibody library on each of the chips.

Subsequently to the incorporation of the probe arrays into the basic strip bodies, as has been described in Example 1, the strips are subjected to a test similar to an ELISA test. To this end, the antibody libraries are first incubated with a primary antibody (human serum), washed and then mixed with a secondary antibody that is simultaneously labeled with biotin.

For colorimetric detection, a conjugate of streptavidin and horseradish peroxidase is incubated and a TMB solution is added. Via the specific interaction of the primary antibody with all areas of the probe array exhibiting anti-human IgG and binding of the secondary biotinylated antibody to the primary antibody, a specific array pattern with precipitate can be detected in the areas of the human IgG via a precipitative detection method using HRP-horseradish peroxidase/TMB.

The tests were conducted according to the following protocol:
1. Washing the probe arrays in the strip with PBS-Tween for 5 min at 23° C.
2. Blocking reaction with 2% BSA in PBS-Tween
3. Incubation of the primary antibody for 1 h at room temperature
4. 3 × washing with PBS-Tween for 5 min at 23° C.
5. Incubation of the secondary antibody for 30 min at room temperature
6. Incubation of a conjugate of streptavidin and horseradish peroxidase (N200, Pierce, USA) in PBS for 30 min at 30° C.
7. 2 × washing with PBS-Tween for 5 min at 23° C.
8. 1× washing with PBS for 5 min at 23° C.
9. Removing the washing solution
10. Detection reaction by means of adding 100 μl TMB solution (71-00-64, KPL, USA) to each well
11. Incubation for 10 min
12. Suctioning the TMB solution
13. Adding 200 μl water

The image recording of the specific precipitate patterns on the probe arrays in the strip according to the present invention is conducted with the aid of a modified AT Reader (Clondiag Chip Technologies GmbH, Jena, Germany). In addition, a linear guide module for defined shifting of the strips according to the present invention allowing the manual steering towards the 8 well positions was incorporated into said AT Reader.

An exemplary recording of a chip stained with TMB, as previously described, in a well of the array strip is depicted in FIG. 6.

### Example 3

### Protein Assay

By means of the device according to the present invention, up to 96 different samples can automatically be examined in at most 12 array strips (CLONDIAG chip technologies GmbH, Jena, Germany) in a genetic or serological test.

In the present example, an array strip is employed for a serological test that is similar to an ELISA test. The microarrays in the individual wells of the array strip contain a library of immobilized antibodies in a layout of 19×19 spots; the library consists of two different antibodies (human IgG and anti-human IgG), each in nine different concentrations, and biotin marker molecules.

In the assay procedure, the incubation of the bioarrays with human serum is conducted first. Herein, the IgG contained in the human serum binds to the anti-human IgG immobilized on the array. After a washing step for removing unspecifically bound protein from the surface of the bioarray, a biotinylated secondary antibody, which in turn binds to human IgG, is brought to react with the biochip. This antibody binds both to the human IgG immobilized on the array and to the human IgG bound to the anti-human IgG from the human serum. After repeated washing steps, a conjugate of streptavidin and horseradish peroxidase is added. Said conjugate in turn binds to the biotin labels of the markers on the array and of the second antibody. Subsequently, via an enzymatically catalyzed reaction at the regions where the conjugate has bound, a precipitate is precipitated, which in turn is then documented by image recording. The procedure of the assay will be described in more detail in the following.

The test proceeds automatically, utilizing the device according to the present invention for all 8 wells of the array strip:

### 1. Preparation of the Device

First, the two tip blocks arranged in the device according to the present invention (referred to as “device” in the following) are each filled up with 96 pipette tips (Cybio AG, Jena, Germany).
An array strip is inserted a conventional microplate frame (for example Greiner Bio-one) and the latter is inserted into the correspondingly provided position of the device.
Further reagents required for the assay, like blocking buffer (PBS-0.01% Tween with 2% BSA (Sigma, Germany)), the prepared stock solution of the biotinylated secondary antibody (goat-anti-human IgG, B-1140, Sigma, Germany, dilution 1:10,000), the prepared stock solution of the conjugate (poly-HRP, N200, Pierce, Germany, dilution 1:10,000), the prepared TMB staining solution (True Blue, KPL, USA) as well as the required washing buffers PBS (155 mM NaCl, 3.77 mM Na₂HPO₄, 17.75 mM Na₂HPO₄, pH 7.4) and PBS 0.01% Tween are filled into the corresponding wells of the Deep Well plates arranged in the device (for example UNIPLATE 10000, 734-2558, VWR, Germany).
The protocol required for the assay is loaded into the program of the connected computer that is responsible for controlling the device.
2. Preparation of the Sample Plate
   100 μl of a 1:12 dilution of human serum in PBS-0.01% casein (Sigma, Germany) are filled into each of the first 8 wells of a standard 96 microtiter plate (for example Greiner Bio-one).
   The plate thus prepared is inserted into the respective position of the device.
   A list of the occupied positions in the master plate with the samples, all of them human serum in this case, is generated via the PC unit.
3. The cover of the device is closed and the program procedure is started at the pertaining PC unit. The subsequently listed steps serve for clarifying the work flow that is automatically conducted by the device without further invention by the user.
1. Conditioning: Taking up a pipette tip and serially filling each of the 8 wells of the array strip with 200 μl of the washing buffer PBS-0.01% Tween. Washing the array strip for 5 min at 23° C. while agitating.
2. Suctioning the washing buffer from all 8 wells of the array strip and subsequent washing of the suction device in the cleaning fountain of the device.
3. Blocking reaction: Taking up a pipette tip and serially filling each of the 8 wells of the array strip with 100 μl of the blocking buffer. Incubation for 5 min at 23° C. while agitating.
4. Suctioning the blocking buffer from all 8 wells of the array strip and subsequent washing of the suction device in the cleaning fountain of the device.
5. Transferring the 100 μl serum in each case in buffer from the sample microtiter plate to the corresponding wells of the array strip. To this end, a pipette tip is taken up, the first sample is suctioned from the sample microtiter plate and is pipetted into the first well of the array strip. Subsequently, the used pipette tip is discarded, a new tip is taken up and the next sample is transferred to the next well of the array strip. This procedure is repeated until all 8 samples are transferred.
6. Incubation for 1 h at room temperature while agitating.
7. Suctioning the sample solution from all 8 wells of the array strip and subsequent washing of the suction device in the cleaning fountain of the device.
8. Washing each of the 8 wells of the array strip 3× with 200 μl PBS-0.01% Tween for 5 min at 23° C. while agitating. A new pipette tip is used for every washing step.
9. Incubation of secondary antibodies: Taking up a pipette tip and serially filling each of the 8 wells of the array strip with 100 μl of the secondary antibody. Incubation for 30 min at room temperature while agitating.
10. Suctioning the secondary antibody from all 8 wells of the array strip and subsequent washing of the suction device in the cleaning fountain of the device.
11. Conjugation: Taking up a new pipette tip and serially filling each of the 8 wells of the array strip with 100 μl of the conjugate of streptavidin and horseradish peroxidase. Incubation for 30 min at 30° C. while agitating.
12. Suctioning the conjugate from all 8 wells of the array strip and subsequent washing of the suction device in the cleaning fountain of the device.
13. Washing each of the 8 wells of the array strip 2× with 200 μl PBS-0.01% Tween for 5 min at 23° C. while agitating. A new pipette tip is used for every washing step.
14. Washing each of the 8 wells of the array strip 2× with 200 μl PBS for 5 min at 23° C. while agitating. A new pipette tip is used for every washing step.
15. Suctioning the last washing solution from all 8 wells of the array strip and subsequent washing of the suction device in the cleaning fountain of the device.
16. Staining: Taking up a pipette tip and serially filling each of the 8 wells of the array strip with 100 μl of the TMB staining solution. Incubation for 10 min at room temperature while agitating.
17. Image recording of all 8 wells of the array strip (see FIG. 9).
18. Computer-controlled evaluation and presentation of the result (see FIG. 10).

### Example 4

### DNA Assay

With the device according to the present invention, up to 96 different samples in a maximum of 12 array strips (CLONDIAG Chip Technologies GmbH, Jena, Germany) can automatically be examined in a genetic or serological test.

In the present example, an array strip for a genotyping assay for determining the genetic predisposition of a patient for thrombosis is employed. The microarrays in the individual wells of the array strip contain a library of immobilized oligonucleotides in a layout of 19×19 spots; the library consists of a set of 12 different probes for genotyping, each of them 12-fold redundant, 2 control probes (each of them also 12-fold redundant) as well as biotin marker molecules. All oligonucleotides are purchased from Ogham Diagnostics, Munster, Germany. FIG. 11 schematically represents the occupation of the array.

First, the assay procedure comprises the incubation of the bioarrays in the array strip with biotin-labeled perfect match oligonucleotides in a suitable buffer first. The biotinylated oligos bind to the corresponding probes of the bioarray according to their sequence. After subsequent washing steps, a conjugate of streptavidin and horseradish peroxidase is added. Said conjugate binds to the biotin label of the markers on the array as well as to the biotinylated oligos that are bound at the bioarray. Subsequently, via an enzymatically catalyzed reaction, a precipitate is precipitated at the sites where the conjugate has bound, which is in turn documented by image recording.

The procedure of the assay is described in more detail in the following.

Analogously to Example 1, the array procedure is automatically conducted utilizing the device according to the present invention for all 8 wells of the array strip:
1. Preparation of the device
   First, the two tip blocks arranged in the device according to the present invention (referred to as “device” in the following) are each filled up with 96 pipette tips (Cybio AG, Jena, Germany).
   A corresponding array strip is inserted a conventional microplate frame (for example Greiner Bio-one) and the latter is inserted into the correspondingly provided position of the device.
   Further reagents required for the assay, like blocking buffer 2×MES (200 mM MES, 2 M NaCl, 40 mM EDTA, 0.1% cetyl dimethyl ethyl ammonium bromide) containing 2% milk powder (Sigma, Germany), the prepared stock solution of the conjugate (poly-HRP, N200, Pierce, Germany, dilution 1:10.000 in 2×MES), the prepared TMB staining solution (True Blue, KPL, USA) as well as the required washing buffers 2×SSC (0.3 M NaCl, 0.03 M Na-citrate, pH 7.0), 2×SSC 0.01% Triton and 0.2×SSC are filled into the corresponding wells of the Deep Well plates arranged in the device (for example UNIPLATE 10000, 734-2558, VWR, Germany).
   The protocol required for the assay is loaded into the program of the connected computer that is responsible for controlling the device.
2. Preparation of the Sample Plates
   Each of the first 8 wells of a standard 96-well microtiter plate (for example Greiner Bio-one) is filled with 100 μl of a solution containing a perfect match oligonucleotide mixture (Ogham, Minster, Germany), in each case at a concentration of c=10 μM in 2×MES (200 mM MES, 2 M NaCl, 40 mM EDTA, 0.1% cetyl dimethyl ethyl ammonium bromide).
   The plate thus prepared is inserted into the correspondingly provided position of the device.
   A list of the occupied positions in the master plate with the samples is generated via the PC unit.
3. The cover of the device is closed and the program procedure is started at the pertaining PC unit. The subsequently listed steps serve for clarifying the work flow that is automatically conducted by the device without further invention by the user.
4. Conditioning the array strip for 5 min at 23° C. while agitating with 200 μl 2×MES.
5. Suctioning the conditioning buffer
6. Transferring the each 100 μl oligo mixture in buffer from the sample microtiter plate to the corresponding wells of the array strip.
7. Incubation for 1 h at 50° C. while agitating.
8. Suctioning the sample solution
9. Washing the array strips with each 200 μl 2×SSC 0.01% Triton, 2×SSC, 0.2×SSC
10. Conjugation with each 100 μl of the conjugate of streptavidin and horseradish peroxidase for 15 min at 30° C. while agitating.
11. Suctioning the conjugate
12. Washing the array strip twice with each 200 μl 2×SSC 0.01% Triton for 5 min at RT while agitating.
13. Washing the array strip with each 200 μl 2×SSC and subsequently 0.2×SSC for 5 min at 20° C. while agitating.
14. Suctioning the last washing solution
15. Staining: adding each 100 μl of the TMB staining solution. Incubation for 10 min at RT.
16. Image recording of all 8 wells of the array strip (see FIG. 12).
17. Computer-controlled evaluation and presentation of the result (see FIG. 13).

### FIGURES

FIG. 1 shows a conventional microtiter plate.

FIG. 2 shows a conventional well strip.

FIG. 3 shows a section of the arrangement of chips in wells of a well strip or ELISA strip.

FIG. 4 shows a standard microtiter plate frame having ten 8-well AT strips.

FIG. 5 shows a modified AT reader having a linear guide module (CLONDIAG Chip Technologies GmbH, Jena, Germany).

FIG. 6 shows the recording of a chip stained with tetramethylbenzidine in a well of an array strip.

FIG. 7 shows an arrangement for the performance and analysis of microarray experiments for detecting a specific interaction between probe and target molecules according to an embodiment of the present invention.

FIG. 8 shows the occupation of the microarrays in the wells of the array strip according to Example 3.

FIG. 9 shows an exemplary photograph of a well of the array strip according to Example 3 after the reaction has occurred.

FIG. 10 is a representation of the result of an assay according to Example 3.

FIG. 11 shows the occupation of the microarrays in the wells of the array strip according to Example 4.

FIG. 12 shows an exemplary photograph of a well of the array strip according to Example 4 after the reaction has occurred.

FIG. 13 is a representation of the result of an assay according to Example 4.

FIG. 14 shows a photograph of two standard reaction tubes made of polypropylene having 1.5 ml filling volume.

FIG. 15 shows an embodiment, in which an opening or a recess (8) having a seat (6), onto which the affinity matrix (100) can be put from the outside, is integrated into the bottom of a reaction tube (2). The affinity matrix (100) is glued by adding the adhesive into a correspondingly provided adhesive rim (7).

FIG. 16 shows an embodiment, in which an opening (10) having a seat (11), onto which the affinity matrix (100) can be put from the inside, is integrated into the bottom of a reaction tube (2). The affinity matrix (100) is glued by adding the adhesive into a correspondingly provided adhesive rim (9).

FIG. 17 shows an embodiment, in which the bottom of a reaction tube (2) is provided with a clamp connection (201). A chip support (200) can be pressed onto said clamp connection (201) in a liquid-proof manner. The chip support has an opening (10), into which the affinity matrix (100) can be put and then glued on a correspondingly provided seat.

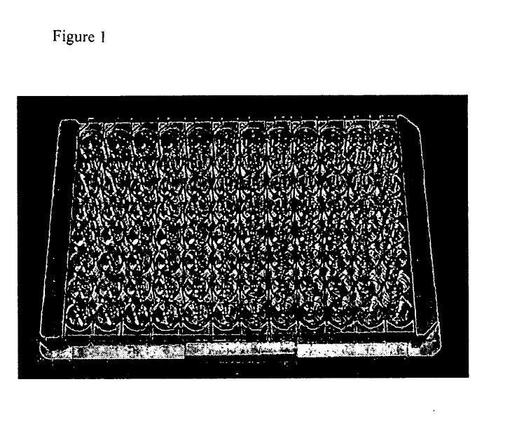

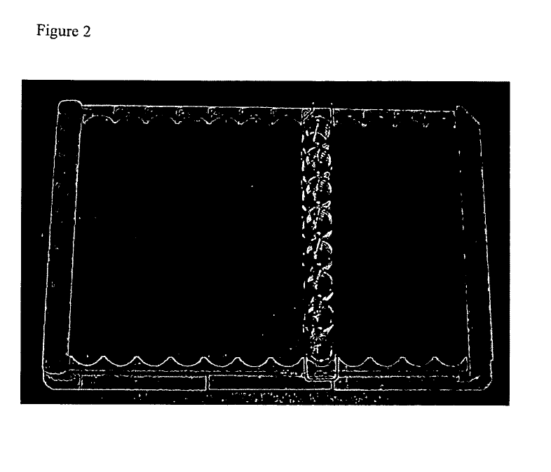

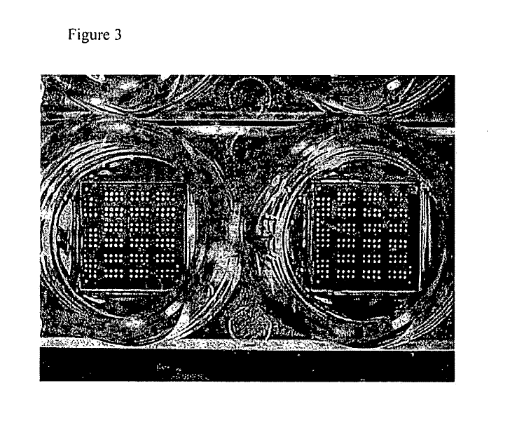

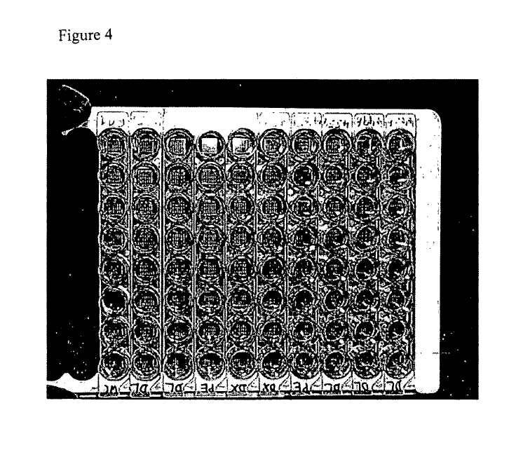

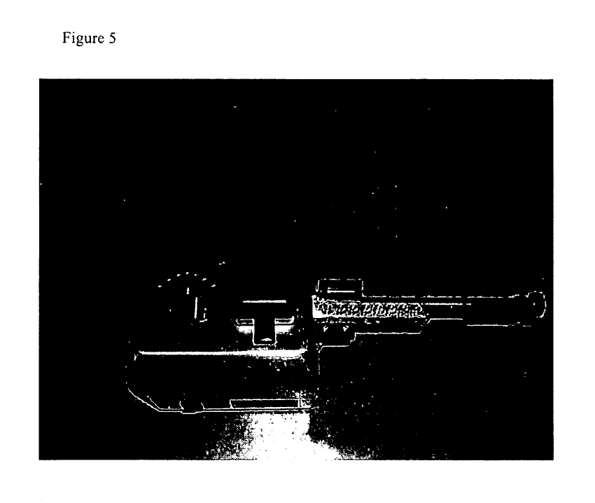

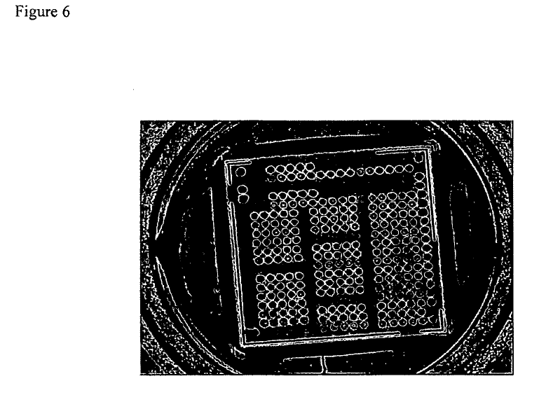

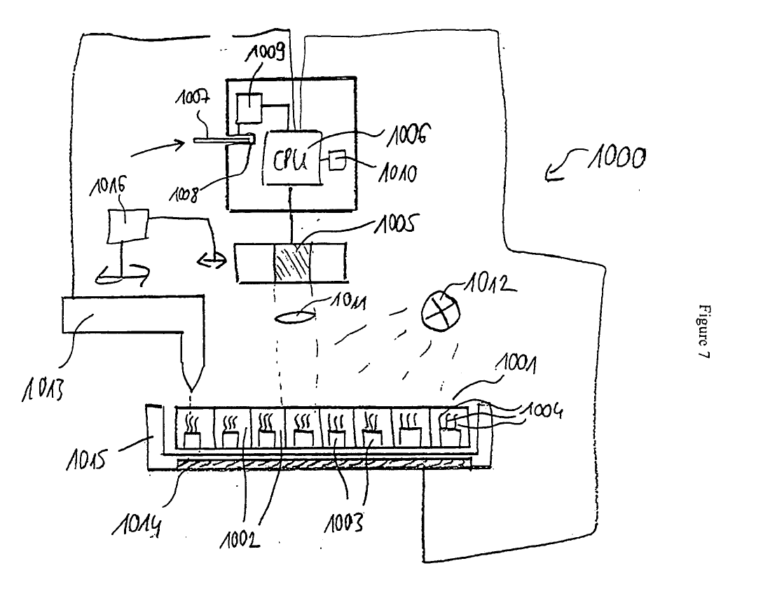

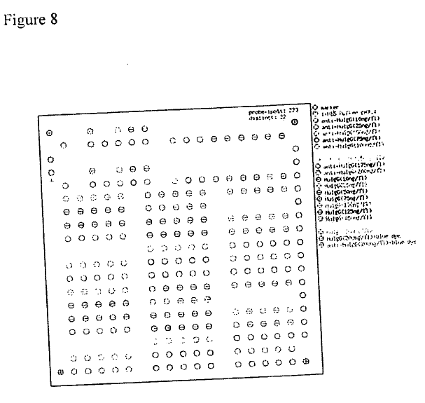

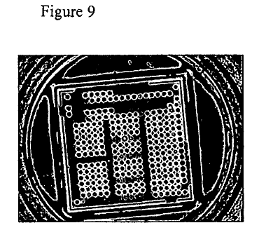

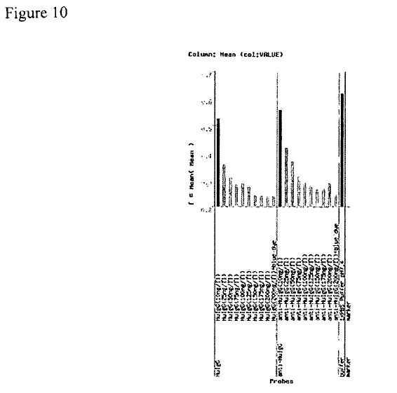

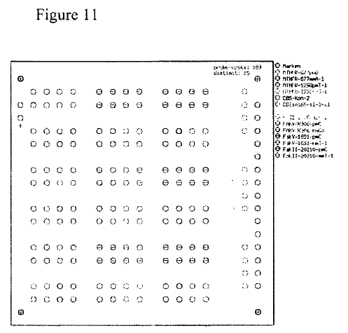

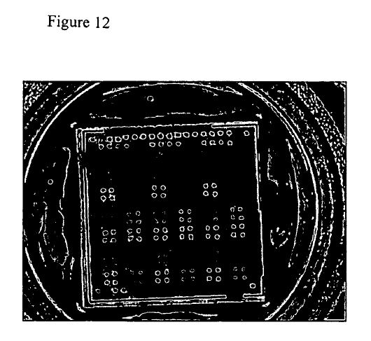

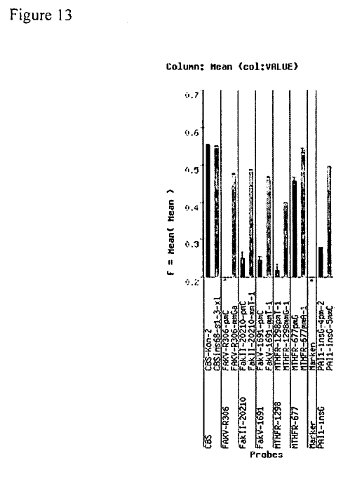

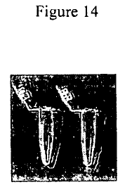

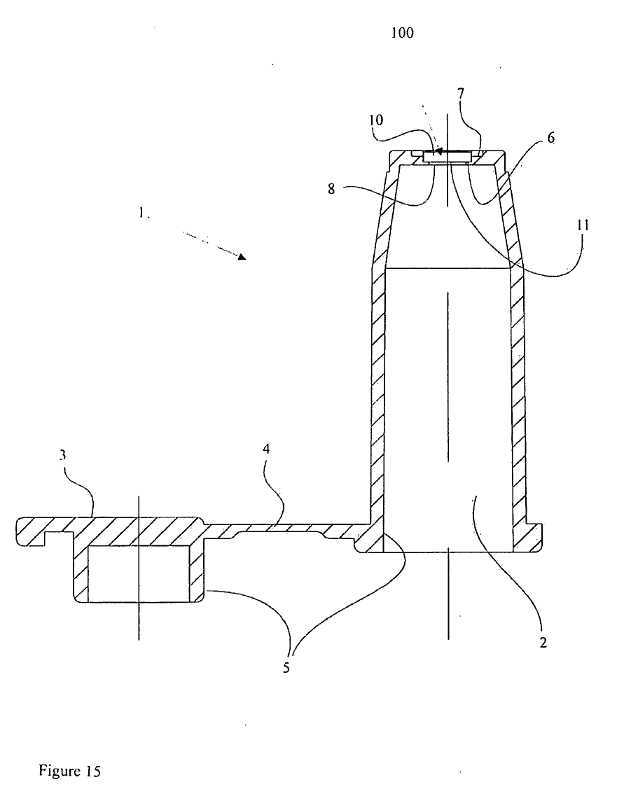

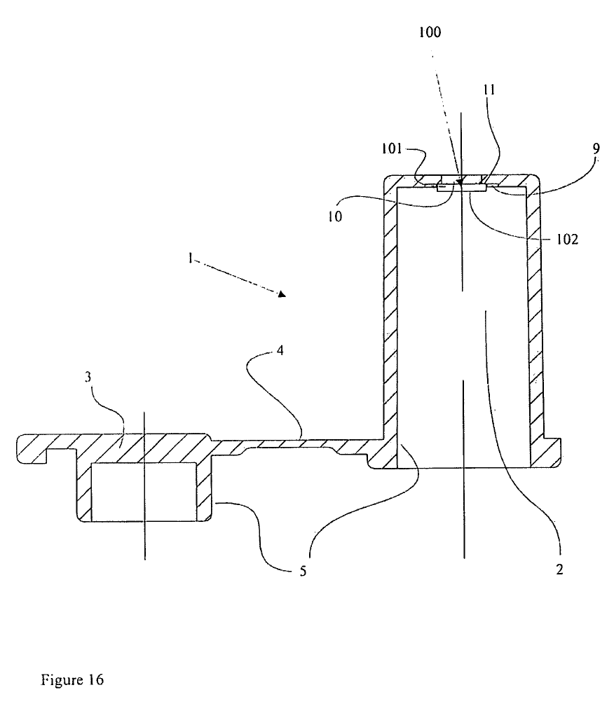

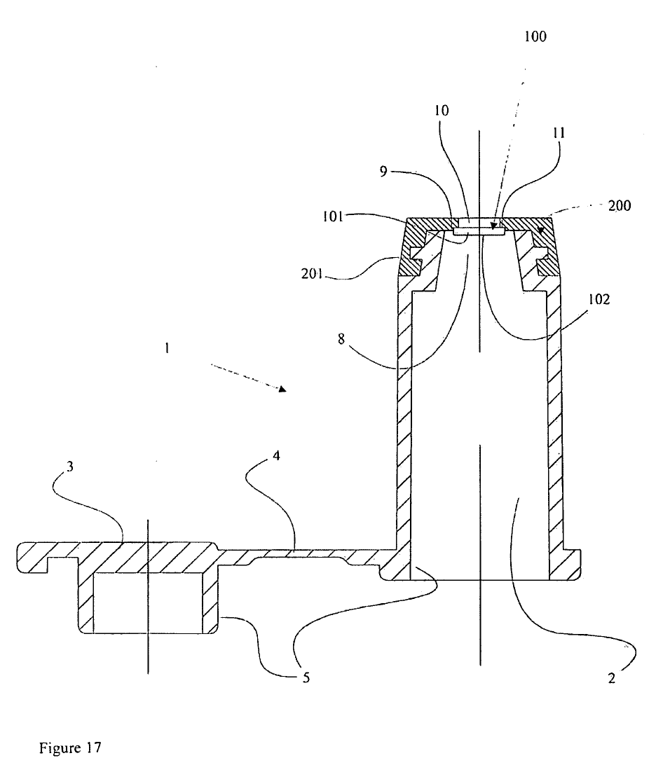

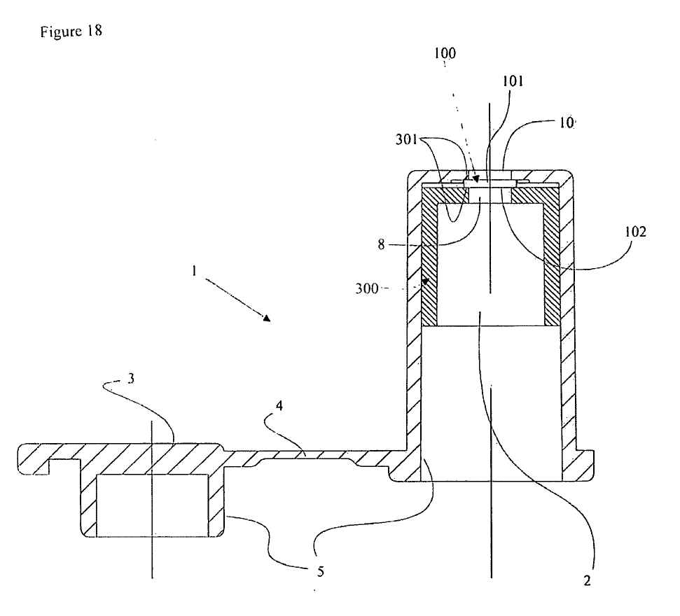

In the embodiment shown in FIG. 18, the affinity matrix (100) is clamped in a liquid-proof manner between the reaction tube (2) and a split taper socket (300), so that gluing is not necessarily required.

1. Device for the simultaneous performance of microarray experiments for detecting a specific interaction between probe and target molecules, comprising a microtiter plate, in wells of which there is each an individual microarray essentially continuously integrated having probes molecules arranged on predetermined regions thereof.

2. Device according to claim 1, wherein one microarray each is fixed on the base of a well and a spacer is located between the microarray and the side walls of the well.

3. Device according to claim 2,
wherein the spacer essentially completely occupies empty spaces between the microarray and the side walls of the well.

4. Device according to claim 1,
wherein the wells each have one retainer in which the microarrays are fixed.

5. Device according to claim 1,
wherein the wells each have one recess in which the microarrays are fixed.

6. Device according to any of the preceding claims,
wherein the microarrays are fixed in an adhesive, clicking, clamping and/or magnetic manner.

7. Device according to claim 6,
wherein an adhesive used for adhesively fixing a microarray to the base of a well essentially completely occupies empty spaces between the microarray and the side walls of the well.

8. Device according to any one of claims 2 to 7,
wherein the spacer and/or the adhesive is an elastomer.

9. Device according to any of the preceding claims,
wherein the microtiter plate is a linear arrangement of eight to twelve wells or a two-dimensional arrangement of optional multiples thereof.

10. Device according to claim 9,
wherein the microtiter plate is a two-dimensional arrangement of 8×12 wells or 16×24 wells.

11. Device according to any of the preceding claims,
wherein the wells have a rectangular, square and/or circular base.

12. Device according to any of the preceding claims,
additionally comprising an optical system having a light source and a detector, wherein light source and detector are located on opposite sides of the microtiter plate.

13. Device according to any of the preceding claims,
wherein the probe molecules are arranged on a rough surface of the microarrays.

14. Device according to any of the preceding claims,
wherein the microarrays comprise a support made of an optically non-transparent material.

15. Method for manufacturing a device for the simultaneous performance of microarray experiments for detecting a specific interaction between probe and target molecules on a microtiter plate whose wells each contain an individual microarray having probe molecules arranged in predetermined regions of the microarray,
wherein the method comprises the following steps:
a) producing microarrays having probe molecules arrangedut in predetermined regions of the microarray;
b) controlling the quality of the microarrays generated in step a);
c) selecting suitable individual microarrays; and
d) fixing the individual microarrays selected in step c) in wells of the microtiter plate.

16. Method according to claim 15,
wherein in step a) at least 50 microarrays are produced on a support.

17. Method according to claim 16,
wherein the microarrays controlled in step b) are located on the support.

18. Method according to claim 16 or 17,
wherein the microarrays selected in step c) are located on the support and are individualized for fixing in the wells.

19. Method according to any of claims 15 to 18,
wherein the microarrays are substantially continuously integrated in wells of the microtiter plate.

20. Method according to claim 19,
wherein the microarrays are each fixed on a base of a well and a spacer is located between the microarray and the side walls of the well.

21. Method according to claim 20,
wherein the spacer essentially completely occupies empty spaces between the microarray and the side walls of the well.

22. Method according to claim 19,
wherein the wells each have a retainer in which the microarrays are fixed.

23. Method according to claim 19,
wherein the wells each have a recess in which the microarrays are fixed.

24. Method according to any of claims 15 to 23,
wherein the microarrays are fixed in an adhesive, clicking, clamping and/or magnetic manner.

25. Method according to claim 24,
wherein an adhesive used for adhesively fixing a microarray on the base of a well essentially completely occupies empty spaces between the microarray and the side walls of the well.

26. Method according to any of claims 20 to 25,
wherein an elastomer is employed as spacer or adhesive.

27. Arrangement for conducting and analyzing microarray experiments for detecting a specific interaction between probe and target molecules comprising:
a microtiter plate, in wells of which there is each an individual microarray essentially continuously integrated having probe molecules arranged in predetermined regions thereof and
a detector device for recording a specific interaction between probe molecules arranged in predetermined regions of the microarray and target molecules.

28. Arrangement according to claim 27,
wherein the microtiter plate is a device according to any of claims 1 to 14.

29. Arrangement according to claim 27 or 28,
further having a processing device for processing the specific interaction recorded by means of the detector device on the basis of an externally selectively predeterminable, preferably validated, processing instruction.

30. Arrangement for conducting and analyzing microarray experiments for detecting a specific interaction between probe and target molecules comprising:
at least one reaction tube in which a microarray having probe molecules arranged in predetermined regions of the microarray is integrated;
a detector device for recording a specific interaction between probe molecules arranged in predetermined regions of the microarray and target molecules;
a processing device for processing the specific interaction recorded by means of the detector device on the basis of an externally selectively predeterminable, preferably validated, processing instruction.

31. Arrangement according to claim 29 or 30,
having an interface means, wherein the processing instruction can be predetermined externally by means of said interface means.

32. Arrangement according to claim 31,
wherein the interface means is a graphical user interface for externally predetermining the processing instruction by a user.

33. Arrangement according to claim 31,
wherein the interface means is provided for receiving and reading out a storage medium in which the processing instruction is stored and which can be externally inserted.

34. Arrangement according to any of claims 27 to 33,
wherein the detector device comprises a camera for optically reading out a specific interaction.

35. Arrangement according to claim 34,
wherein said camera is a CCD camera.

36. Arrangement according to claim 34 or 35,
wherein said camera is produced according to CMOS technique.

37. Arrangement according to any of claims 34 to 36,
wherein the detector device has an imaging optics located between the camera and the microarray.

38. Arrangement according to any of claims 27 to 37,
wherein the detector device comprises a light source.

39. Arrangement according to claim 38,
wherein the light source is for homogenously illuminating the microarray.

40. Arrangement according to claim 38 or 39,
wherein the light source is selected from the group consisting of a laser, a light-emitting diode, a surface emitter and a high-pressure lamp.

41. Arrangement according to any of claims 27 to 29 and 31 to 40,
having a liquid supply device for introducing a liquid into wells of the microtiter plate.

42. Arrangement according to any of claims 30 to 40,
having a liquid supply device for introducing a liquid into the at least one reaction tube.

43. Arrangement according to any one of claims 27 to 29 and 31 to 41,
having a temperature adjusting unit installed for adjusting a temperature for each of the wells of the microtiter plate.

44. Arrangement according to any of claims 30 to 40 and 42,
having a temperature adjusting unit for adjusting a temperature in the reaction tube.

45. Arrangement according to claim 43 or 44,
having a moving device by means of which the detector device and/or the microarray(s) and/or the liquid supply device and/or the liquid discharge device and/or the temperature adjusting device is/are movable in any predeterminable direction, wherein preferably the microarray(s) and/or the microtiter plate has/have a marker for position correction.

46. Method for processing a specific interaction between target molecules and probe molecules arranged in predetermined regions of a microarray that has been recorded by means of an arrangement for conducting and analyzing microarray experiments, wherein in the method a specific interaction recorded by means of a detector device is processed on the basis of an externally selectively predetermined processing instruction.

47. Method according to claim 46,
wherein a selective processing according to a microarray experiment selected from a plurality of possible microarray experiments is conducted on the basis of the externally selectively predetermined processing instruction.

48. Method according to claim 46 or 47,
wherein, on the basis of the externally selectively predetermined processing instruction, a selective processing is conducted for the microarray experiment performed according to at least one selected experimental parameter.

49. Method according to any of claims 46 to 48,
wherein, on the basis of the externally selectively predetermined processing instruction, a selective validated processing is conducted according to a special microarray experiment.

50. Computer-readable storage medium in which a program is stored for processing a specific interaction between target molecules and probe molecules arranged in predetermined regions of a microarray that has been recorded by means of an arrangement for conducting and analyzing microarray experiments, wherein with the program, in case it is conducted by means of a processor, a specific interaction recorded by means of a detector device is processed on the basis of an externally selectively predetermined processing instruction.

51. Program element, in which a program is stored for processing a specific interaction between target molecules and probe molecules arranged in predetermined regions of a microarray that has been recorded by means of an arrangement for conducting and analyzing microarray experiments, wherein with the program, in case it is conducted by means of a processor, a specific interaction recorded by means of a detector device is processed on the basis of an externally selectively predetermined processing instruction.

52. Use of a device according to any of claims 1 to 14 or of a device according to any of claims 27 to 45 in a method for detecting the specific interaction between probe and target molecules, comprising the following steps:
a) interaction of a target with probes arranged in predetermined regions (array elements) of the microarray; and
b) detecting said interaction.

53. Use according to claim 52,
wherein the formation of a precipitate on the array elements is detected.

54. Use according to claim 53,
wherein the time course of the formation of a precipitate on the array elements is detected.

55. Use according to claim 53 or 54,
wherein the reaction leading to the formation of a precipitate on the array elements is the conversion of a soluble educt to form an insoluble product in the presence of a catalyst that is coupled to the targets.

56. Use according to claim 55,
wherein the catalyst is an enzyme.

57. Use according to claim 56,
wherein the enzyme is selected from horseradish peroxidase, alkaline phosphatase and/or glucose oxidase.

58. Use according to any one of claims 55 to 57,
wherein the soluble educt is selected from 3,3′-diaminobenzidine, 4-chloro-1-naphthol, 3-amino-9-ethylcarbazole, p-phenylenediamine-HCl/pyrocatechol, 3,3′,5,5′-tetramethylbenzidine, naphthol/pyronine, bromochloroindoylphosphate, nitrotetrazolium blue and/or phenazine methosulfate.
